(19) United States
(12) Patent Application Publication
(10) Pub. No.: US 2025/0386064 A1
(43) Pub. Date: Dec. 18, 2025

(54) DYNAMIC SYSTEMS AND METHODS FOR MEDIA-AWARE TRANSPORT OF FRAGMENT OF CONTENT IN LOW-LATENCY, OVER-THE-TOP, AND ADAPTIVE BITRATE STREAMING

(71) Applicant: Adeia Guides Inc., San Jose, CA (US)

(72) Inventors: Dhananjay Lal, Englewood, CO (US); Christopher Phillips, Hartwell, GA (US); Reda Harb, Tampa, FL (US)

(21) Appl. No.: 18/744,547

(22) Filed: Jun. 14, 2024

(51) Int. Cl. H04N 21/235

(52) U.S. Cl. CPC H04N 21/2355

(57) ABSTRACT

Low latency, over-the-top (OTT), and/or adaptive bitrate (ABR) content streaming is provided. Content delivery is enhanced by determining if a fragment of a content segment at a content delivery network (CDN) edge node meets a threshold for preferential encapsulation and transport. If met, preferential encapsulation and transport to the client device is provided; otherwise, it defaults to non-preferential encapsulation. The size of the fragment is quantified at a parser of the CDN edge node or an ABR segment encryption system. The ABR system may be connected between a content source and a CDN origin and may include an encryptor that sends CMAF video and audio segment's fragment byte offsets metadata. Also, the CDN edge node may include the ABR system and an encryptor that sends an encrypted CMAF segment's fragment size to a threshold calculator of an HTTP server. Related apparatuses, devices, techniques, and articles are also described.

### FIELD OF THE DISCLOSURE

The present disclosure relates to content delivery, including low latency, over-the-top (OTT), and/or adaptive bitrate (ABR) content streaming.

### SUMMARY

While OTT ABR streaming has been on the rise, the performance of live ABR streaming leaves much to be desired. The latency of live OTT ABR streaming today lags behind live streaming over cable. Live transmissions are also known to be unpredictable and may buffer frequently. For example, Hypertext Transfer Protocol (HTTP)-based OTT ABR streaming, also known as HTTP Adaptive Streaming (HAS), has seen a surge in demand for live content. However, it faces challenges in providing low latency for interactive experiences with live content. This is due, for example, to the buffering of, for example, three video segments for playout reliability, which is problematic for applications requiring lower latency.

Encoding video at a set bitrate presents another challenge. The encoder averages out to a bitrate over time, achieved by a defined buffer model on a client device. This allows the encoder to encode intra pictures (I-pictures), predicted pictures (P-pictures), and bidirectional pictures (B-pictures), which all vary in size. The differences between one frame and the next also impacts the picture size, making some content harder to encode than others. For instance, a basketball game is more difficult to encode than many types of content due to significant differences from one picture to the next.

Streaming for ultralow latency use-cases typically uses Real Time Protocol (RTP), working in conjunction with Real Time Control Protocol (RTCP). However, OTT ABR live streaming, a low latency use case, is a pull model where the client device requests segments for download over HTTP.

The Moving Picture Experts Group (MPEG)-4 Part 14 (MP4) container format, created for file-based content, needed improvements for use in ABR streaming. This led to the addition of the Common Media Application Format (CMAF) to the MP4 specification, allowing the multiplexer to include a new box called the movie fragment box (MOOF) into the multiplexed stream. This enables the segment to be subdivided into fragments, reducing latency for initial playout of video.

Many internet applications are queue-building, i.e., they use buffering in the network and at the receiver. However, congestion-control mechanisms have not evolved significantly since the early days of the internet. These mechanisms can introduce latency, jitter and packet loss—not only to themselves but also to other applications using the network at the same time. With low latency, low loss, and scalable throughput (L4S), network service providers have introduced dual queueing in their network, providing a “priority lane.” However, this “priority lane” is used by ultralow latency, non-queue-building traffic.

Media-over-Quick UDP Internet Connections (QUIC) Transport (MOQT) and Media Over QUIC (MOQ) are protocols for low-latency media ingest and distribution, targeting applications like live streaming, cloud gaming, and videoconferencing. They achieve a better quality-latency tradeoff and support different media formats and encodings. However, they face challenges in ensuring low latency, high scalability, and defining how media publication can leverage relays and caches to enhance delivery.

QUIC Protocol and HTTP/3 overcome transmission control protocol (TCP)'s downsides by offering reduced latency, improved multiplexing, connection migration, and enhanced security. HTTP/3 uses QUIC instead of TCP for a more efficient and secure web. However, these new protocols suffer from compatibility issues with older devices and reduce inspection visibility. Firewalls may find inspecting network traffic for threats challenging due to QUIC's foundation on User Datagram Protocol (UDP). HTTP/3requires encryption, impacting infrastructure and architecture, and making it difficult for “middle boxes” to inspect traffic.

Extensible Prioritization Scheme for HTTP allows an HTTP client to communicate its preferences for how the upstream server prioritizes responses. It replaces the previous RFC 7540 stream priority due to its shortcomings. However, it depends on in-order delivery of signals, leading to challenges in porting the scheme to protocols that do not provide byte-ordering guarantees.

TCP Tahoe, TCP Reno, and their variants are TCP congestion control techniques. They use a combination of Slow Start, Additive Increase Multiplicative Decrease (AIMD), and Fast Retransmit or Fast Recovery. However, they face challenges when packet losses are high. TCP Reno's performance is almost the same as Tahoe under high packet loss conditions, and it does not perform well when multiple packet losses occur in one window.

Mathis Model for TCP Throughput is used to estimate TCP throughput in network paths, particularly in environments with regular packet loss. However, it does not provide accurate throughput estimates when thousands of flows compete at high bandwidths.

TCP Congestion Control is a method for managing data flow and preventing network congestion implemented for each data transfer connection sharing the network. However, it faces challenges including being misled by non-congestion losses, high delays, underutilization of the network due to short flows completing before discovering available capacity, and impracticality of the AIMD mechanism for high-speed links. Other issues include unfairness under heterogeneous Round Trip Times (RTTs), tight coupling with reliability mechanisms leading to inefficiencies, performance degradation in wireless networks, and the diversity in the characteristics of present and next-generation networks and a variety of application requirements. These challenges underscore the complexity of TCP congestion control and the need for improvement.

Furthermore, when a network link is congested, latency on the network link generally increases. Traditionally, this has often occurred primarily because of certain congestion control mechanisms utilized by a sender transmitting data on the network link, rather than due to a lack of available capacity on the network link. Such congestion control mechanisms attempt to estimate currently available capacity on the network link based on implicit signals interpreted from receiver feedback and, in some cases, explicit signals from the network, in order to allow the sender to adjust its data transmission rate accordingly. However, such congestion control mechanisms often cause queuing delay, e.g., application providers often send data too quickly for the network to queue it up.

For example, as stated in Internet Engineering Task Force (IETF), “Low Latency, Low Loss, and Scalable Throughput (LAS) Internet Service: Architecture,” RFC 9330 January 2023, (referred to herein as RFC 9330), the contents of which are hereby incorporated by reference herein in their entirety, “queuing remains a major, albeit intermittent, component of latency. For instance, spikes of hundreds of milliseconds are not uncommon, even with state-of-the-art Active Queue Management (AQM) . . . . It has been demonstrated that, once access network bit rates reach levels now common in the developed world, increasing link capacity offers diminishing returns if latency (delay) is not addressed.” RFC 9330 further states that “Queuing delay degrades performance intermittently. . . . It occurs when a large enough capacity-seeking (e.g., TCP) flow is running alongside the user's traffic in the bottleneck link, which is typically in the access network, or ii) when the low latency application is itself a large capacity-seeking or adaptive rate flow (e.g., interactive video).”

The L4S standard has been introduced to help address these issues. As stated in RFC 9330, “This document describes the L4S architecture, which enables Internet applications to achieve low queuing latency, low congestion loss, and scalable throughput control. L4S is based on the insight that the root cause of queuing delay is in the capacity-seeking congestion controllers of senders, not in the queue itself. With the L4S architecture, all Internet applications could (but do not have to) transition away from congestion control algorithms that cause substantial queuing delay and instead adopt a new class of congestion controls that can seek capacity with very little queuing. These are aided by a modified form of Explicit Congestion Notification (ECN) from the network. With this new architecture, applications can have both low latency and high throughput. The architecture primarily concerns incremental deployment. It defines mechanisms that allow the new class of L4S congestion controls to coexist with ‘Classic’ congestion controls in a shared network. The aim is for L4S latency and throughput to be usually much better (and rarely worse) while typically not impacting Classic performance.”

Traditional single-queue buffering of internet packets at a network component such as an access network router suffers from head-of-line (HOL) blocking, effectively making high latency-sensitive traffic wait in a queue behind less latency-sensitive traffic, which adversely affects the customer's quality of experience (QoE). The L4S mechanism helps address this issue using dual queueing in the wide area network (WAN), with one queue at a network node (or a network bottleneck node) dedicated to low latency packets and the other queue dedicated to classic traffic, and makes reasonable assumptions about performance of network-dependent low latency applications such as gaming, AR/VR, voice, etc., to deliver an improved service, to perform scalable congestion control. However, while L4S attempts to do justice to highly latency-sensitive applications (e.g., near real-time latency, requiring a round trip time of between about 1 millisecond and about 100 milliseconds), it is not meant to provide low latency content delivery, e.g., via OTT ABR streaming or HAS.

To help address the limitations and problems of these and other approaches, low latency content delivery, e.g., via OTT ABR streaming or HAS, is provided, including preferential processing (e.g., via L4S) for certain fragments exceeding a threshold. For example, low latency content delivery, requiring a round trip time of between about 1 second to about 10 seconds, such as HAS, is improved with one or more preferential service flows described herein, particularly when bandwidth surges occur. Also, for example, a method includes determining at a content delivery network (CDN) edge node if a quantification of a fragment of a segment of the content to be encapsulated and transported satisfies a threshold. Further, for example, if the quantification satisfies the threshold, the method causes preferential (e.g., L4S) encapsulation and transport of at least a fragment of the segment to a client device. Still further, for example, if the quantification does not satisfy the threshold, default (e.g., non-L4S) encapsulation and transport of the segment to the client device is provided. Moreover, for example, in some embodiments, the quantification is a size of the fragment, which is determined at a parser of the CDN edge node or at an ABR segment encryption system. Furthermore, for example, in some embodiments, the ABR segment encryption system is operatively connected between a content source and a CDN origin. In addition, the CDN origin is operatively connected between the ABR segment encryption system and the client device.

Throughout the present specification, terms such as segment, fragment, and chunk may be provided. In some embodiments, e.g., in ABR streaming, a stream is split into pieces of up to a few seconds in duration, which are called segments. Segments are the primary units of content that are downloaded and played back by the client. Also, for example, a segment is internally subdivided into smaller units, called fragments. Fragments allows a player to start demultiplexing the video and/or audio without having to download the full segment, which could be between a few seconds to about 10 seconds. Further, for example, chunks are even smaller pieces of a segment. Chunks can have a shorter duration than segments. For example, a fragment may have a duration of about 180 milliseconds (ms); whereas a segment may have a duration of about 6 seconds. The use of chunks allows for more granular control over the streaming process, which can help to reduce latency and improve the responsiveness of the stream. These terms are not intended to be limiting, and other types of partitions of content may be provided in any suitable manner.

In some embodiments, the ABR segment encryption system includes an encryptor connected to the parser, which receives the size of the fragment from the parser. For example, the encryptor causes common media application format (CMAF) video and audio segment's fragment byte offsets metadata to be sent to and/or across at least one of a CDN origin, a CDN, or the CDN edge node. Also, for example, in some embodiments, the CDN edge node comprises the ABR segment encryption system, and an encryptor connected to the parser. Further, for example, the encryptor receives the size of the fragment from the parser and sends an encrypted CMAF segment's fragment size to a threshold calculator of an HTTP/3 server of the CDN edge node. Still further, for example, the preferential encapsulation and transport of the segment includes tagging the fragment for the L4S service. Moreover, for example, tagging is performed by an HTTP/3 server of the CDN edge node or a parser of the CDN edge node. Furthermore, for example, a threshold calculator of the CDN edge node performs the determination of whether the quantification of the fragment of the segment of the content to encapsulate and transport the fragment satisfies the threshold.

In some embodiments, the threshold is based at least in part on a CMAF segment's fragment size and a segment's requested bitrate. For example, in some embodiments, the fragment is broken down into one or more transport packets, and the method includes streaming a plurality of transport packets from the L4S service and a non-L4S service, storing these packets in respective buffers, resequencing the packets prior to demultiplexing and decoding, and storing the packets for transmission at the CDN edge node and the client device in respective buffers. Also, for example, in some embodiments, a CMAF fragment includes, at its smallest, an entire I-picture, P-picture, or B-picture. Further, for example, such CMAF fragment including the entire I, P, or B picture may require a plurality of transport packets to deliver an encoded picture.

Related devices, systems, formulas, non-transitory, computer-readable media, and the like are also provided.

The present invention is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate identically or functionally similar elements, of which:

FIG. 1 depicts a CDN edge node for low latency content delivery, e.g., via OTT ABR streaming or HAS, by tagging certain fragments for preferential processing (e.g., via L4S), in accordance with some embodiments of the disclosure;

FIG. 2 depicts an example process for determining whether a quantification of a fragment of a segment of content to be encapsulated and transported satisfies a threshold, in accordance with some embodiments of the disclosure;

FIG. 3 depicts an ABR segment encryption system and a CDN edge node (e.g., connected via a CDN origin and a CDN) for low latency content delivery, e.g., via OTT ABR streaming or HAS, by tagging certain fragments for preferential processing, in accordance with some embodiments of the disclosure;

FIG. 4 depicts a CDN edge node, e.g., including a decryption unit or decryption module, i.e., a decryptor as used herein, and an ABR segment encryption system including an encryptor, for low latency content delivery by tagging certain fragments for preferential processing, in accordance with some embodiments of the disclosure;

FIG. 5 depicts an example of CMAF-enabled MP4 multiplexing with segments subdivided into fragments, in accordance with some embodiments of the disclosure;

FIG. 6 depicts an example of live fragment distribution from a CDN origin for precaching at edge nodes leveraging multicast distribution, in accordance with some embodiments of the disclosure;

FIG. 7 depicts an example of a client device initially requesting live service 1, in accordance with some embodiments of the disclosure;

FIG. 8 depicts an example chart of congestion windows for TCP Tahoe and TCP Reno, in accordance with some embodiments of the disclosure;

FIG. 9 depicts an example of a table of explicit congestion notification (ECN) markings in a packet internet protocol (IP) header, in accordance with some embodiments of the disclosure;

FIG. 10 depicts examples of ranges of latencies for various types of applications and/or protocols, in accordance with some embodiments of the disclosure;

FIG. 11 depicts an example system for a prioritized CMAF fragment delivered to a client device where encrypted segments leave data required to parse an MP4 CMAF segment (movie (MOOV) and movie fragment (MOOF) boxes) “in the clear” and/or unencrypted, in accordance with some embodiments of the disclosure;

FIG. 12 depicts another example system for a prioritized CMAF fragment delivered to a client device including encrypted segments and fragment byte offset metadata for all generated CMAF segment's fragments for a live stream, in accordance with some embodiments of the disclosure;

FIG. 13 depicts still another example system for a prioritized CMAF fragment delivered to a client device including encrypted segments where an MP4 container fragment size parser is incorporated into an encryption system, in accordance with some embodiments of the disclosure;

FIG. 14 depicts an example process for creating CMAF segment's fragments (e.g., for the devices and systems shown in FIGS. 1, 4, 11 and 13), in accordance with some embodiments of the disclosure;

FIG. 15 depicts an example process for creating CMAF segment's fragments (e.g., for the devices and systems shown in FIGS. 3 and 12), in accordance with some embodiments of the disclosure;

FIG. 16 depicts an example process for a client requesting a CMAF live segment in a bitrate ladder based on a client device's ABR player calculating bandwidth and a CDN edge node delivering a segment enabling or disabling L4S based on at least one of a bitrate of a segment's fragment to be delivered, a client's estimated bandwidth, or a size of the fragment from the segment to be delivered, in accordance with some embodiments of the disclosure;

FIG. 17 depicts an example process for enabling or disabling L4S based on MOOV and MOOF atoms in the clear, in accordance with some embodiments of the disclosure;

FIG. 18 depicts an example process for enabling or disabling L4S based on an OTT ABR system producing a video and audio segment's byte offsets metadata file, in accordance with some embodiments of the disclosure;

FIG. 19 depicts an example process for enabling or disabling LAS based on an OTT ABR system with MOOV and MOOF boxes not in the clear and where there is no video and audio segment's byte offsets metadata file, in accordance with some embodiments of the disclosure;

FIG. 20 depicts an example process for transmission and reception of packets via L4S and non-L4S pathways with separate buffers for a sender device and a receiver device, in accordance with some embodiments of the disclosure;

FIG. 21 depicts an example process for low latency content delivery, in accordance with some embodiments of the disclosure;

FIG. 22 depicts one or more steps of an example process for low latency content delivery that may be combinable with one or more steps of the process of FIG. 21, in accordance with some embodiments of the disclosure;

FIG. 23 depicts an example of an artificial intelligence system, in accordance with some embodiments of the disclosure; and

FIG. 24 depicts an example of a communication system including a server, a communication network, and a computing device for performing the methods and processes, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

Imagine watching your favorite show online, but the video keeps buffering, causing you to miss the action. Presented herein are methods and systems for delivery of video (e.g., packets) more efficiently. The way videos are streamed over the internet, especially for live events, is improved. The methods include a decision on when to use a faster delivery route, based, for example, on a size of a video packet, fragment, or chunk. In some embodiments, a separate or preferential stream is utilized for larger video packets. This ensures that the larger packets do not get lost or arrive too early, which can cause the video to stutter or pause. As a result, video plays more smoothly, with less buffering. The user experience (UX) is improved even when trying to change channels quickly or rewind the video (e.g., using a trick play function in OTT). Also, features are provided for preventing the video quality from dropping down too much when the calculated internet speed is close to the threshold video encoded bitrate limit. In summary, the live streaming experience is improved by using the network more effectively.

In some embodiments, HTTP OTT ABR delivery is optimized. For example, low-latency delivery for ABR streaming with QUIC transport (e.g., raw QUIC or HTTP/3) is provided. Also, for example, a determination is made at a sender device to use a low latency queuing pathway, e.g., via selective L4S enablement, based on fragment size being above a threshold. Further, for example, QUIC streams are utilized to enable selective L4S. Still further, for example, leveraging the fact that each QUIC stream uses its own flow control and congestion control mechanisms, a separate QUIC stream for L4S-enabled packets is provided. The separate QUIC stream for L4S-enabled packets ensures an ability to independently receive L4S packets from non-L4S packets without inferring packet loss due to earlier arrival of L4S packets versus non-L4S packets.

Although instantaneous throughput may increase when viewed on a timescale of segments (e.g., throughput increases for a fragment), average throughput increases when viewed on a timescale of transport packets. The likelihood of video stutter, glitching, playback interruption, and other latency-dependent undesirable artifacts in live OTT ABR streaming is decreased. User interactivity is improved on a timescale of hundreds of milliseconds (e.g., fast channel change, or the like) as well as initial rendering when a user time-shifts the video farther back than the currently playing segment. Additionally, for example, a client device is prevented from moving to a lower bitrate when the client device's calculated bitrate is close to the client device's threshold limit. Also, for example, a move down an ABR bitrate ladder to a lower bitrate provides an improved UX to the viewer of the content.

In some embodiments, performance of live OTT ABR streaming is improved by leveraging a low latency pathway over a network in a manner that the “queue building” nature of low latency pathways does not adversely affect network performance.

### Numbering Convention in Certain Drawings

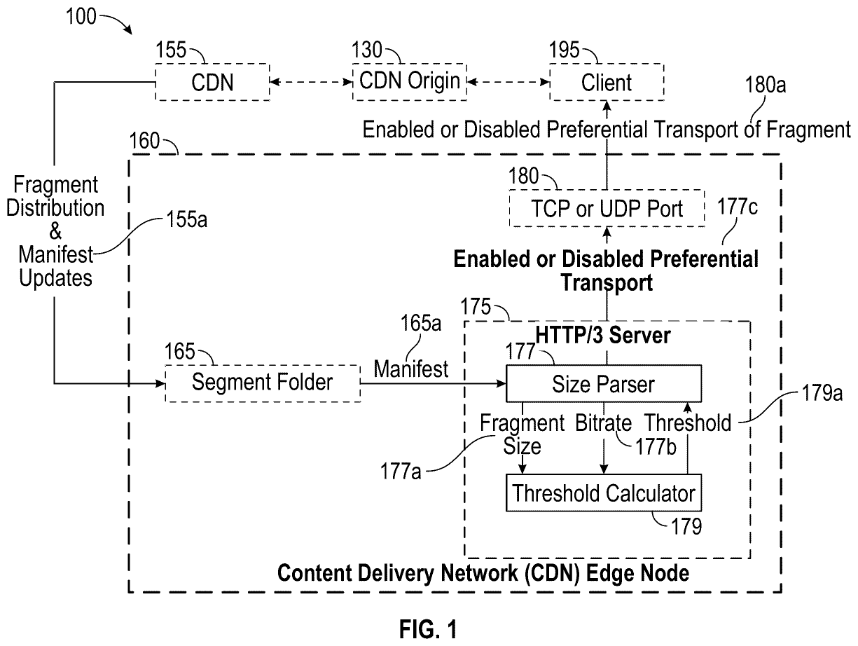

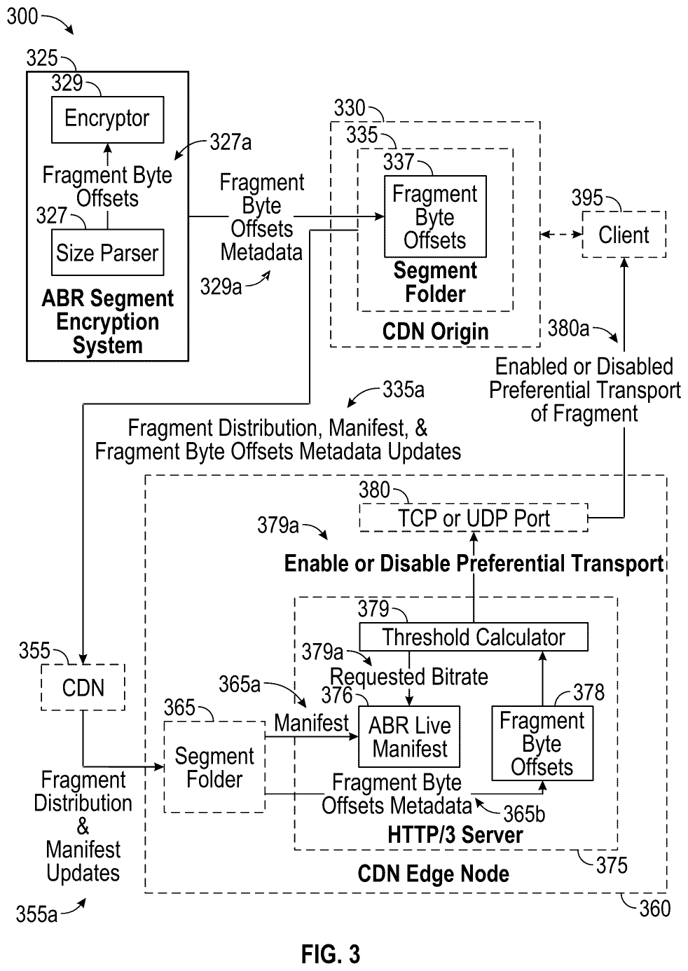

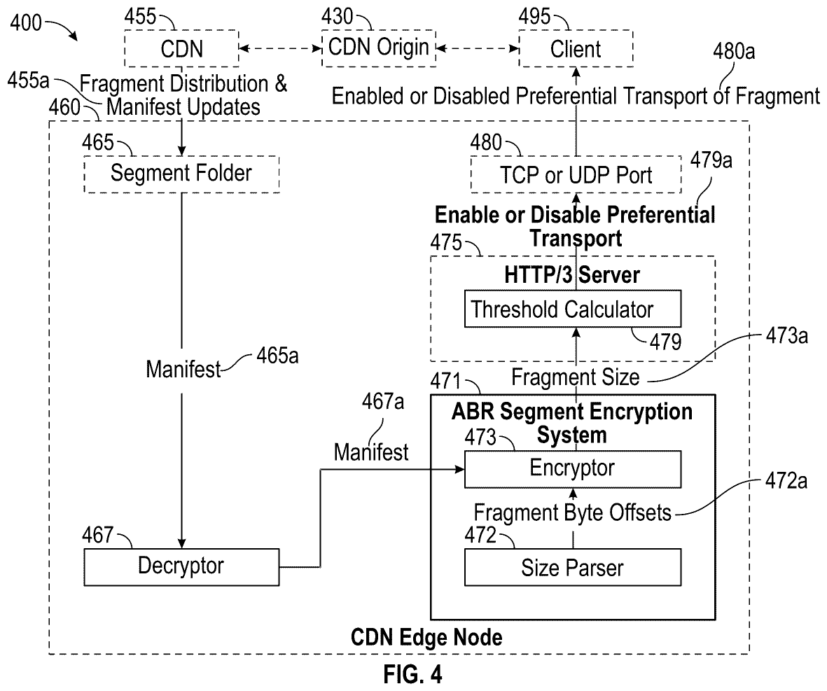

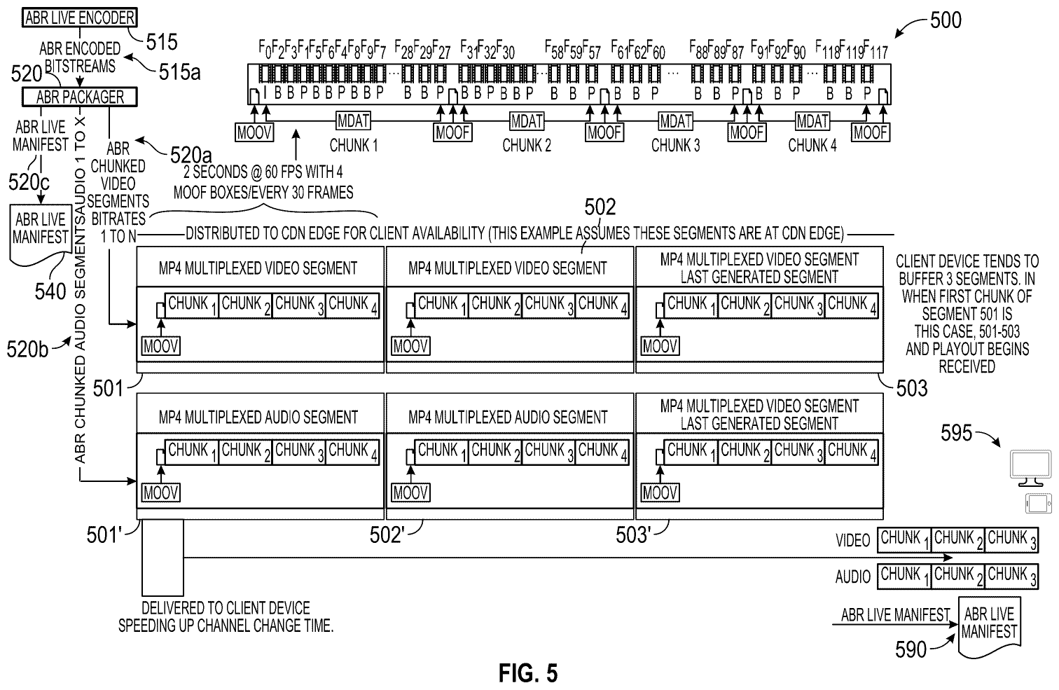

In overview, it is noted that in each of FIGS. 1, 3-7, and 11-13, each feature is numbered with a three digit or four-digit number using a convention of XYZ or XXYZ, with X or XX corresponding to the number of the figure, and YZ identifying a feature. Where the last two digits, YZ, are the same between two or more figures, in general, to the extent possible, the features may be considered to be like or similar unless otherwise described. Where there are variations between embodiments of like- or similarly named features having the same last two digits, clarifying descriptions are provided. For example, CDN 155 in FIG. 1 may be similar to CDN 355 in FIG. 3, CDN 455 in FIG. 4, CDN 655 in FIG. 5, and so on. Also, information exchanged (e.g., transmitted and received, either directly or indirectly) between identified features, often associated with lines or one or two-headed arrows between features, are numbered using a convention of XYZa or XXYZa, with, for example, a lowercase a (b, c, etc.) corresponding with one or more types of information associated with a directly or indirectly adjacent feature, and the numbering of the information may identify an exemplary source and/or sender of the information. With the lowercase letters (unlike XYZ or XXYZ), like lowercase letters (suffixes) as between the various embodiments may not necessarily have similar descriptions (but may have similar descriptions, depending on the embodiment). Further, where a one-headed arrow is provided, it does not imply one-way communication unless otherwise evident from context. For the sake of brevity, once a feature is described initially, if it is not subsequently described, it may be assumed that subsequent features with the same last two digits may be similar to the initially described feature, as appropriate to the particular circumstances of the embodiments being discussed or unless stated otherwise. That is, for the sake of brevity, like numbered features may or may not be subsequently discussed. Still further, any feature is not necessarily limited by any other description of a like numbered feature. Moreover, one or more features of like numbered features may be added, omitted, combined, duplicated, and/or modified in any suitable combination.

In some embodiments, a system and process are provided for low latency content delivery, such as OTT ABR streaming or HAS, by tagging certain fragments for preferential processing. The system includes a CDN origin, where content is hosted; a CDN, which is a network of servers that cache and deliver content; and a CDN edge node, which delivers content to the client device. The CDN edge node is located close to the client device to reduce latency. The CDN edge node includes a segment folder for storing content segments, an HTTP/3 server for efficient content delivery, and a TCP or UDP port for data transmission.

In the described process, the CDN sends fragment distribution and manifest updates to the CDN edge node. The size parser in the CDN edge node determines the fragment size and bitrate for transmission. Based on these, the threshold calculator determines a threshold. If a fragment size exceeds this threshold, preferential transport is enabled; otherwise, default transport is used.

The system optimizes content delivery by managing how data is parsed, stored, and transported, ensuring efficient and reliable access for the end-user. The inclusion of preferential transport provides a level of control over the priority of content delivery. The process adaptively selects an encapsulation and transport method for maintaining performance and user experience. The system also includes an ABR segment encryption system, which sends fragment byte offsets to the CDN origin. The CDN edge node receives these updates and sends them to the HTTP/S server. When a fragment is about to be delivered to the client device, the threshold calculator reads the manifest for the segment to determine the bitrate of the requested segment and the size of the fragment to be delivered. The threshold calculator determines a threshold size based on the requested segment bitrate and the size of the CMAF segment's fragment size. This system and related processes optimize network transport of content and ensure efficient delivery of content to end-users.

Also, a system includes a CDN edge node with a decryptor, and an ABR segment encryption system with an encryptor. This system is designed for low latency content delivery by marking certain fragments for priority processing.

FIG. 1 depicts a system 100 including a CDN edge node 160 for low latency content delivery, e.g., via OTT ABR streaming or HAS, by tagging certain fragments for preferential processing (e.g., via L4S), in accordance with some embodiments of the disclosure. For example, the system 100 includes at least one of a CDN origin 130, a CDN 155, a CDN edge node 160, a client device 195, combinations of the same, or the like. Although on CDN edge node 160 is illustrated, it is understood that a plurality of CDN edge nodes may be operated in accordance with any of the embodiments provided herein. Also, for example, the CDN origin 130 is the origin server where content is hosted. Further, for example, the CDN 155 is a system of interconnected servers that cache and deliver content over the internet. Further, for example, the CDN edge node 160 delivers content to the client device 195. Still further, for example, the CDN edge node 160 is located relatively close to a location of the client device 195 to reduce latency. Moreover, for example, the client device 195 is an end-user device that requests content from the CDN 155.

In some embodiments, the CDN edge node 160 includes at least one of a segment folder 165, an HTTP/3 server 175, a TCP or UDP port 180, combinations of the same, or the like. For example, the segment folder 165 is a storage component for content segments before they are delivered. Also, for example, the HTTP/3 server 175 is a server that uses the HTTP/3 protocol, which is designed for efficient content delivery. Further, for example, the TCP or UDP port 180 is used for transmitting data between the CDN edge node 160 and the client device 195. Still further, for example, the CDN edge node 160 includes at least one of a size parser 177, a threshold calculator 179, combinations of the same, or the like.

In an example process, the CDN 155 causes fragment distribution and manifest updates 155a, which update a manifest file that dictates how content is organized and delivered, to be sent to the CDN edge node 160. For example, the CDNCDN edge node 160 receives the fragment distribution and manifest updates 155a and are placed in the segment folder 165. Also, for example, the segment folder 165 sends a manifest 165a to the HTTP/3 server 175. Further, for example, the size parser 177 receives the manifest 165a. Still further, for example, the size parser 177 determines a fragment size 177a of at least one fragment in the manifest 165a. Moreover, for example, the size parser 177 determines a bitrate 177b for transmission of at least one segment in the manifest 165a. Furthermore, for example, the threshold calculator 179 determines a threshold 179a based at least in part on the fragment size 177a and the segment bitrate 177b.

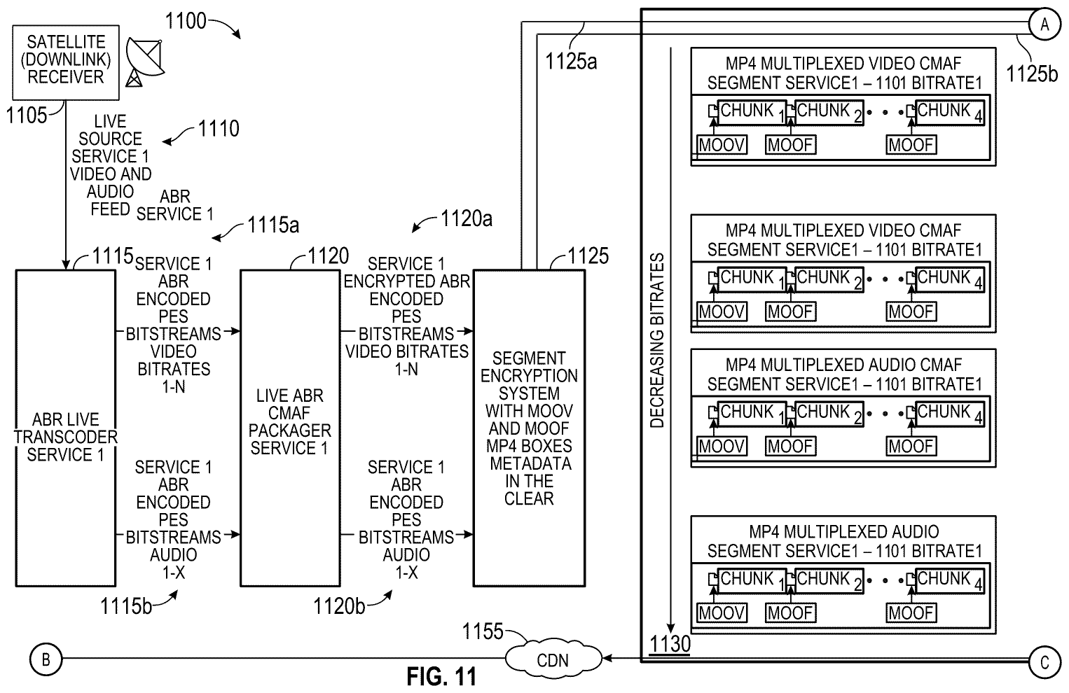

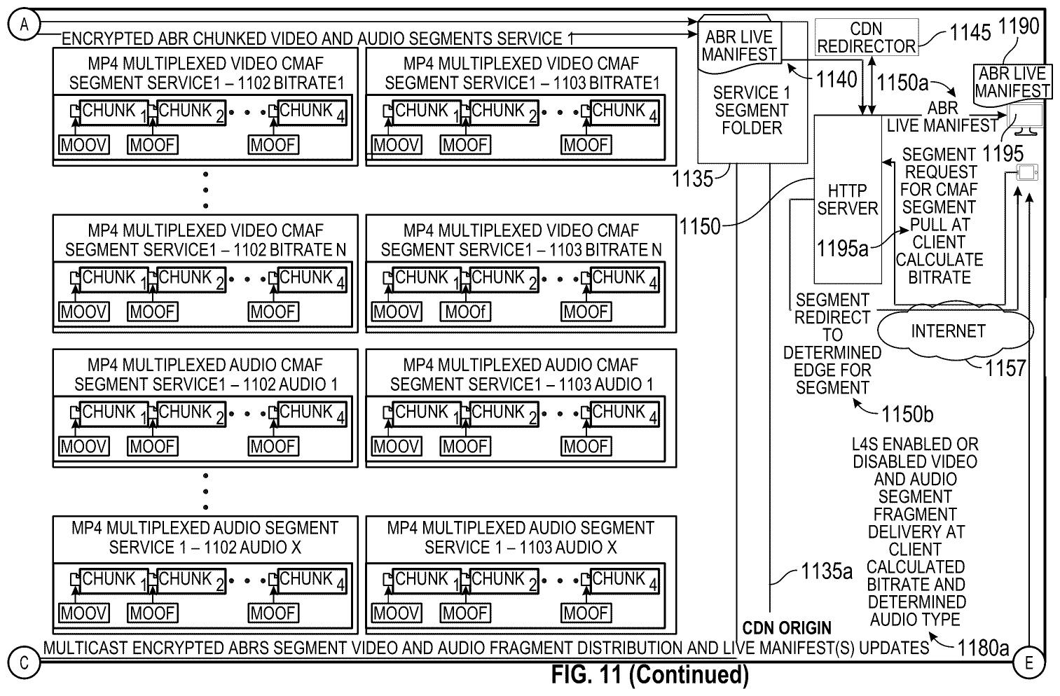

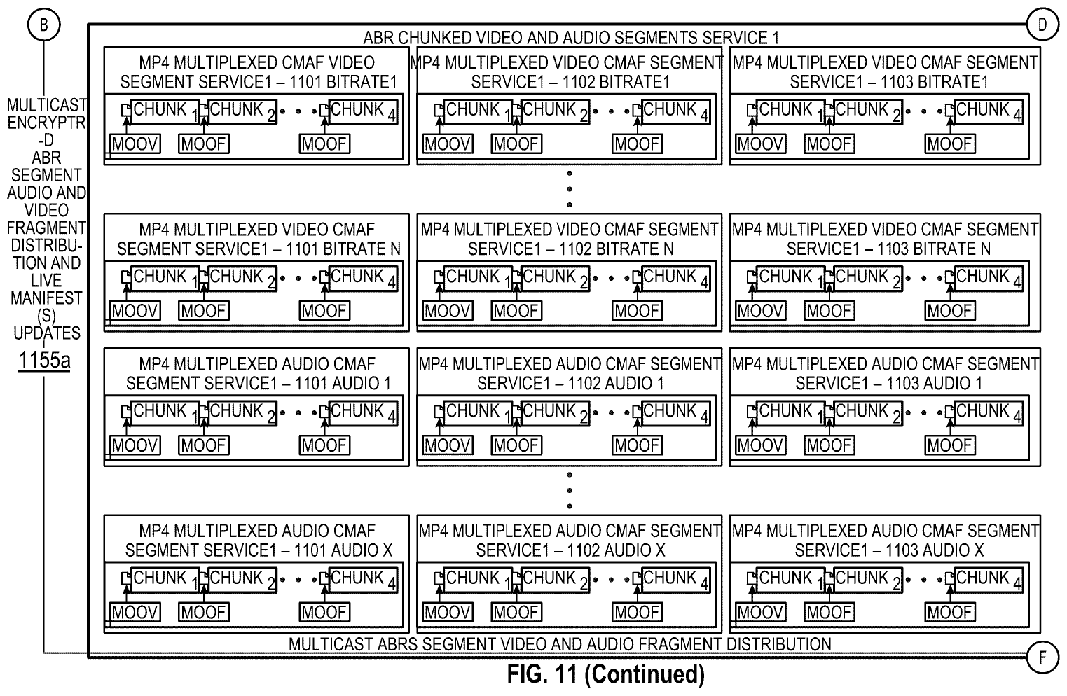

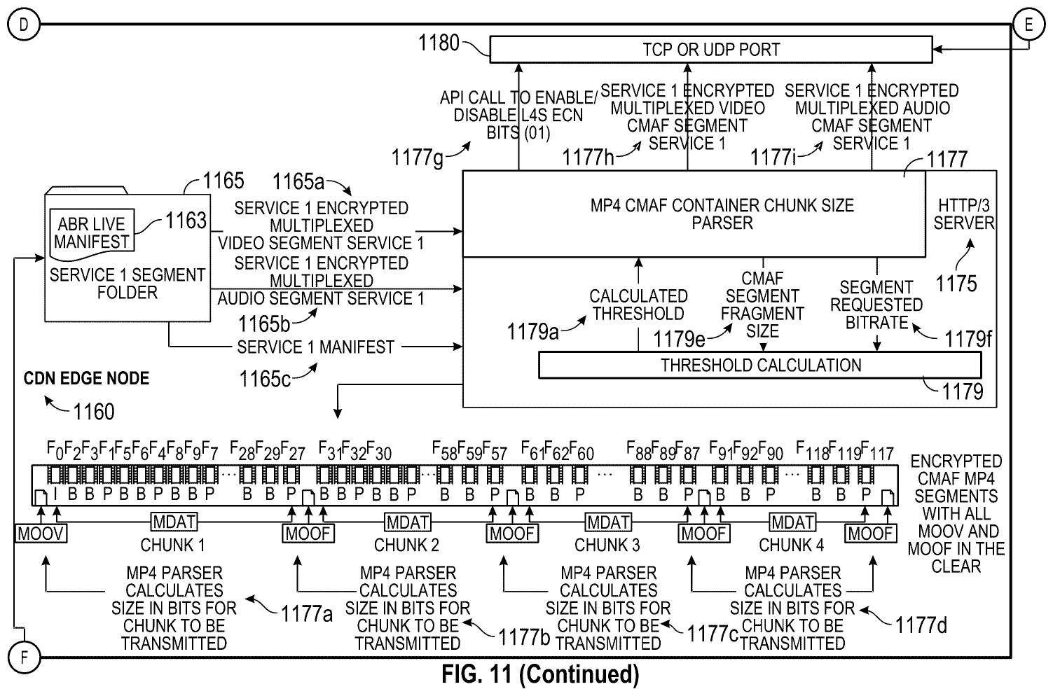

In some embodiments, the size parser 177 causes to transmit information for enabling or disabling preferential transport 177c of at least one fragment. For example, the size parser 177 sends information for enabling or disabling preferential transport 177c of at least one fragment's transport packets to the TCP or UDP port 180. Also, for example, the TCP or UDP port 180 causes enabled or disabled preferential transport of at least one fragment's transport packets 180a to the client device 195. The system 100 optimizes delivery of content by managing how data is parsed, stored, and transported, ensuring efficient and reliable access for the end-user. The inclusion of preferential transport provides a level of control over the priority of content delivery. Additional embodiments of the system 100 of FIG. 1 are provided with reference to FIG. 11 herein.

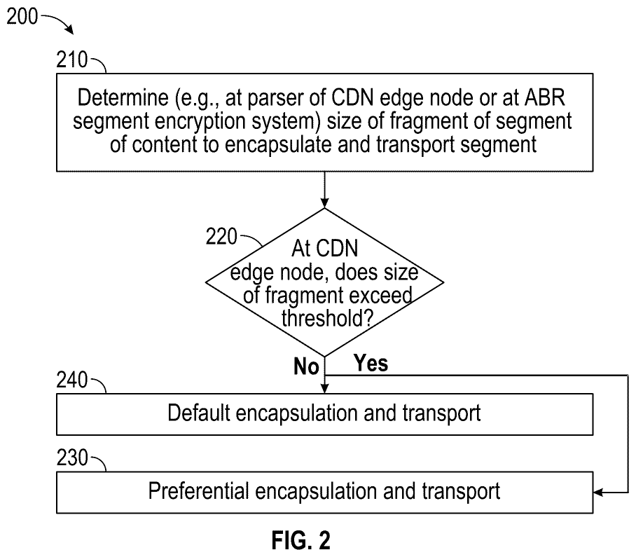

FIG. 2 depicts an example process 200 for determining whether a quantification of a fragment of a segment of content to be encapsulated and transported satisfies a threshold, in accordance with some embodiments of the disclosure. The process 200 optimizes network traffic and ensures efficient delivery of content to end-users. The process 200 includes handling of transport data packets, manifests, segments, containers, fragments, chunks, or atomics based on their size. For example, a relatively large fragment size may negatively impact streaming quality and buffering times for videos and other media. The process 200 adaptively selects an encapsulation and transport method, which maintains performance and user experience. Also, for example, the process 200 is provided for a CDN edge node and/or an ABR segment encryption system. Further, for example, the process 200 includes determining 210 a size of a fragment of content to encapsulate and transport a fragment's packets. Still further, for example, the process 200 includes determining 220 whether a size of the fragment exceeds a threshold. Moreover, for example, based at least in part on determining the size of the fragment exceeds the threshold (220=“Yes”), the process 200 includes providing 230 preferential encapsulation and transport. In addition, for example, based at least in part on determining the size of the fragment does not exceed the threshold (220=“Yes”), the process 200 includes providing 240 default encapsulation and transport.

FIG. 3 depicts a system 300 including an ABR segment encryption system 325 and a CDN edge node 360 (e.g., connected via a CDN origin 330 and a CDN 355) for low latency content delivery, e.g., via OTT ABR streaming or HAS, by tagging certain fragments for preferential processing, in accordance with some embodiments of the disclosure. For example, the system 300 includes a threshold calculator 379 of an HTTP/3 server 375 of the CDN edge node 360. Also, for example, the system 300 includes a size parser 327 as part of the ABR segment encryption system 325.

In some embodiments, a size parser 327 of the ABR segment encryption system 325 sends fragment byte offsets 327a to an encryptor 329 of the ABR segment encryption system 325. For example, the encryptor 329 sends fragment byte offsets metadata 329a to a fragment byte offsets storage 337 of a segment folder 335 of the CDN origin 330. Also, for example, the segment folder 335 sends fragment distribution, manifest, and fragment byte offsets metadata updates 335a to the CDN 355. Further, for example, the CDN 355 sends fragment distribution and manifest updates 355a to the CDN edge node 360.

In some embodiments, a segment folder 365 of the CDN edge node 360 receives the fragment distribution, manifest, and fragment byte offsets metadata updates 335a and sends a manifest 365a and fragment byte offsets metadata 365b to the HTTP/S server 375. For example, an ABR live manifest 376 receives the manifest 365a. Also, for example, a fragment byte offsets storage 378 receives the fragment byte offsets metadata 365b and sends this information to the threshold calculator 379. Further, for example, the threshold calculator 379 sends a requested bitrate 379a to the ABR live manifest 376.

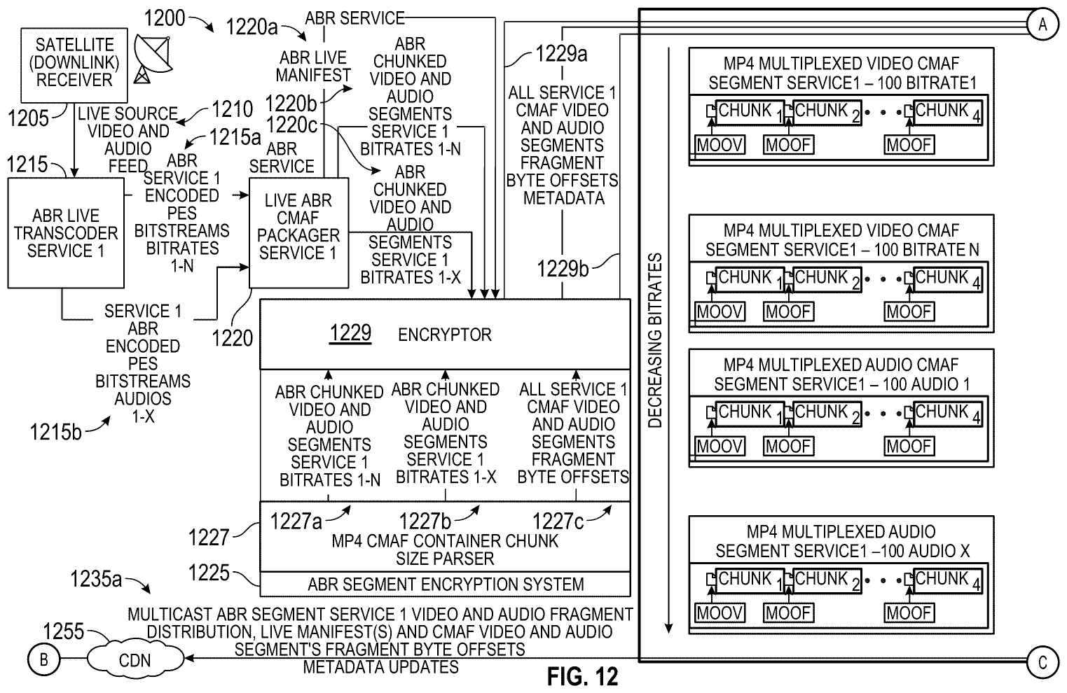

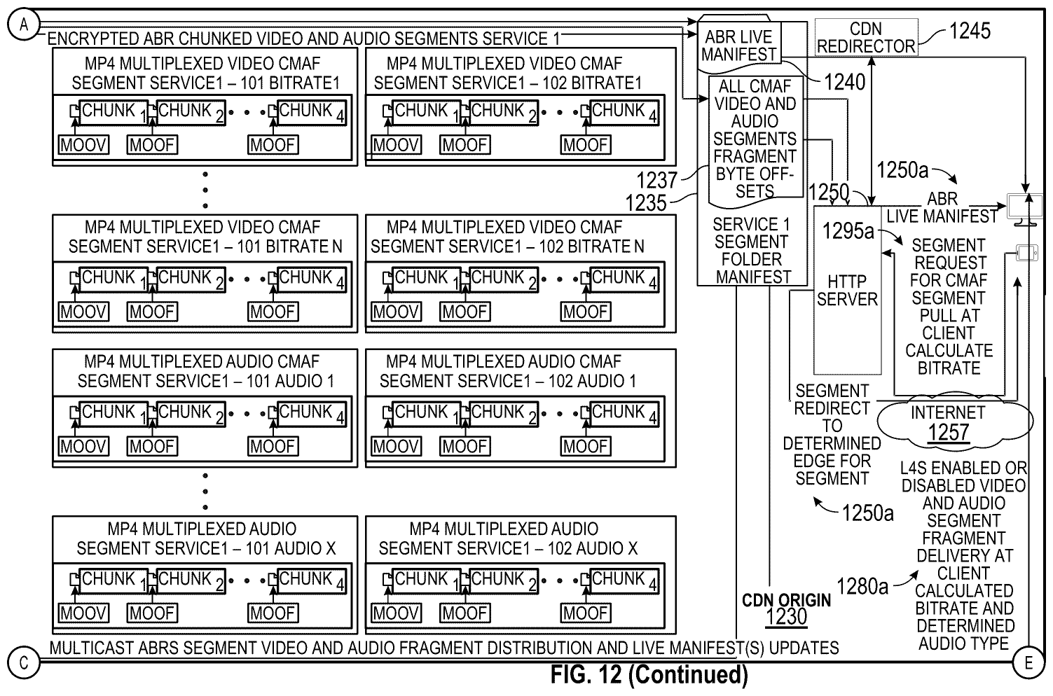

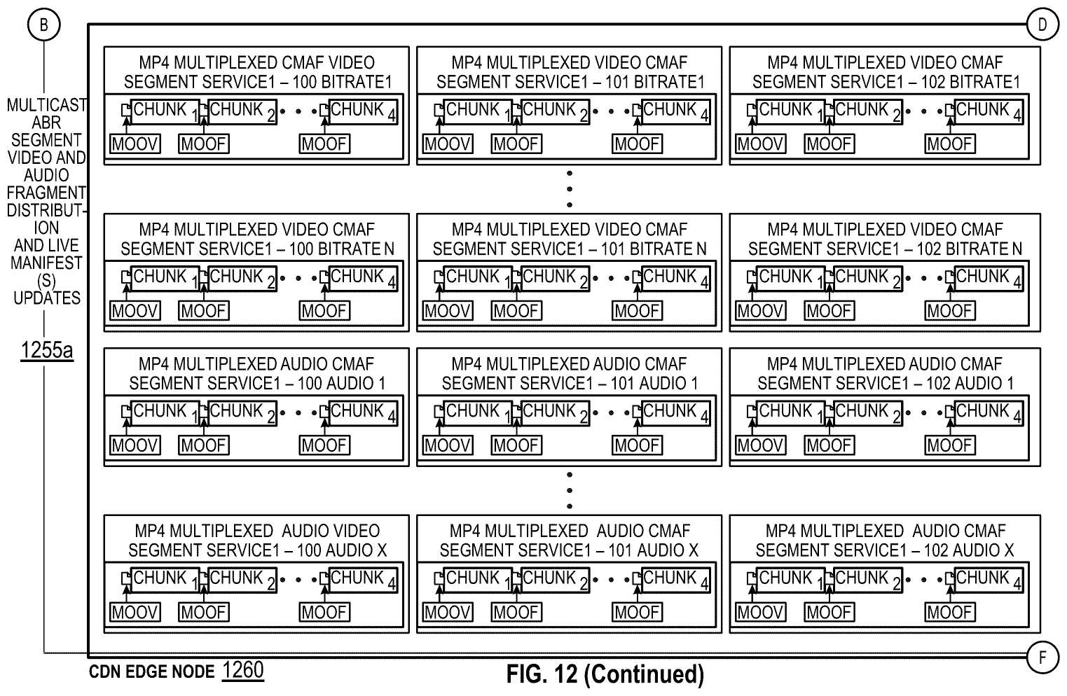

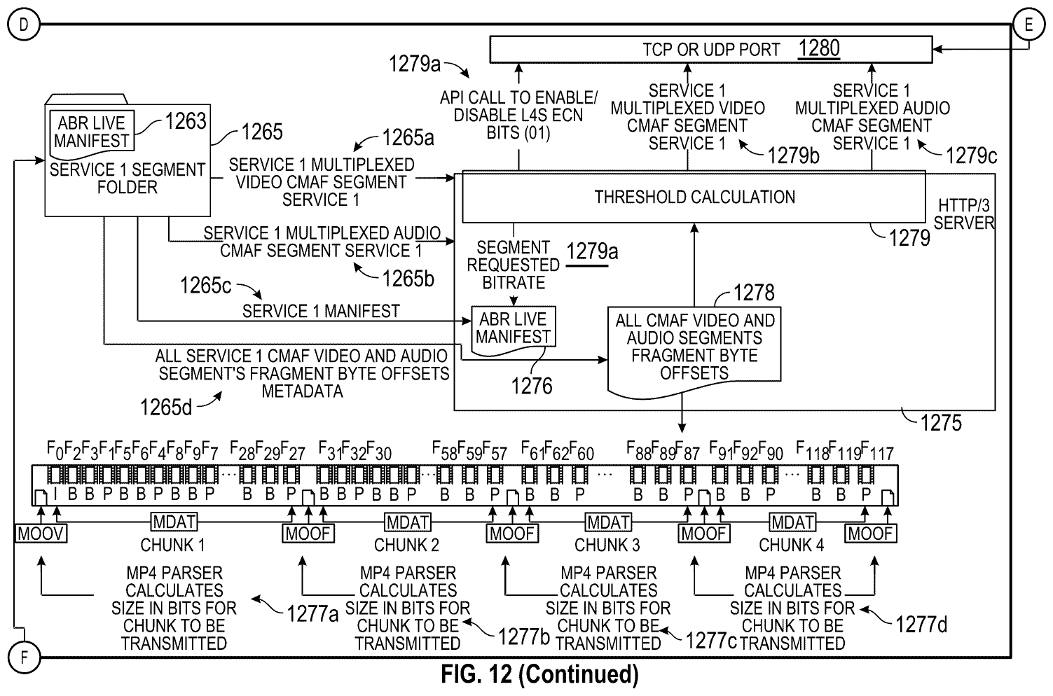

In some embodiments, when a fragment is about to be delivered to the client device 395, the threshold calculator 379 in the HTTP/3 server 375 reads the manifest 365a for the segment to be delivered to the client device 395 to determine the bitrate 379a of the requested segment. For example, the threshold calculator 379 reads the byte offsets (e.g., from the metadata 365b) for the current fragment to be delivered and determines the size of the fragment. Also, for example, as noted in greater detail herein, the threshold calculator 379 determines a threshold size based at least in part on the requested segment bitrate 379a and the size of the CMAF segment's fragment size, which is the next fragment to deliver to the requesting client device 395. Additional embodiments of the system 300 of FIG. 3 are provided with reference to FIG. 12 herein.

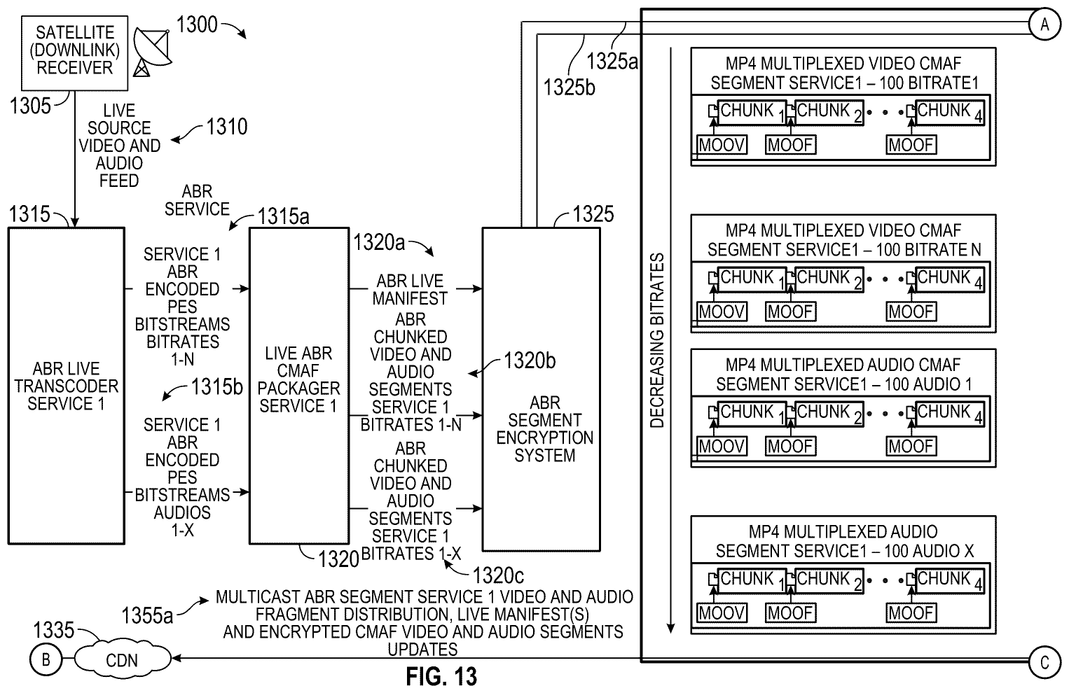

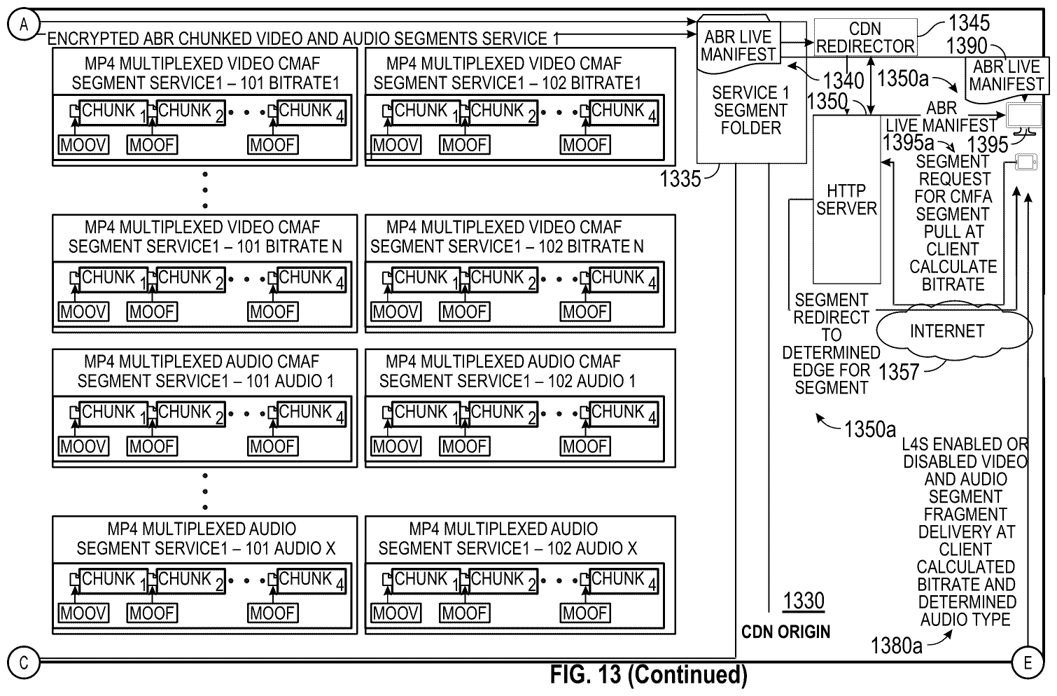

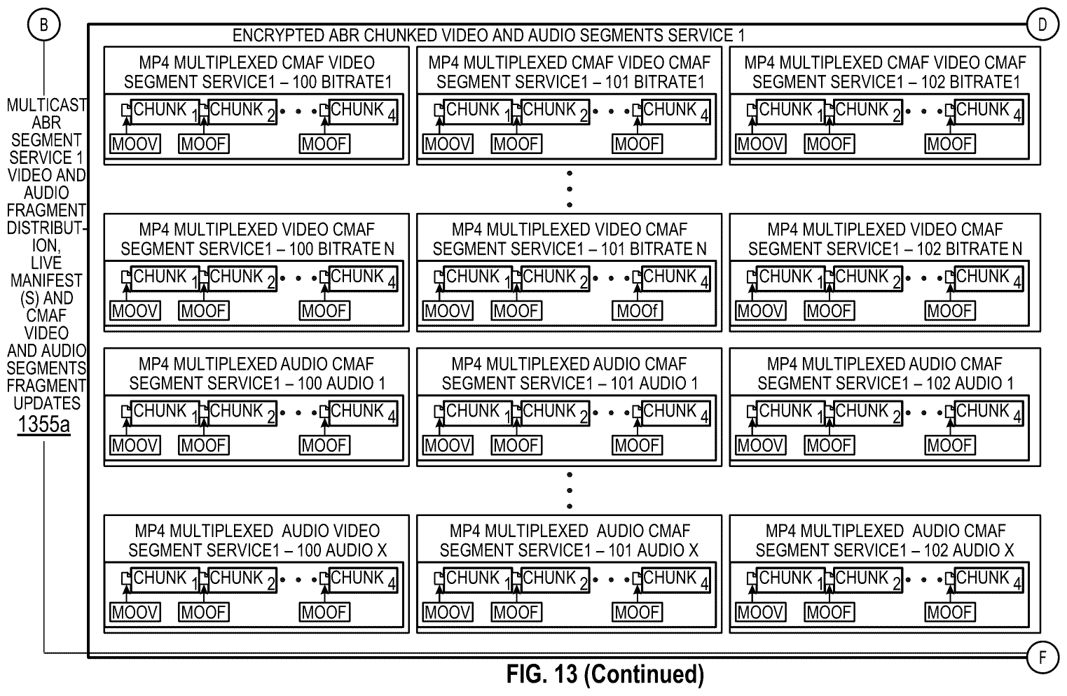

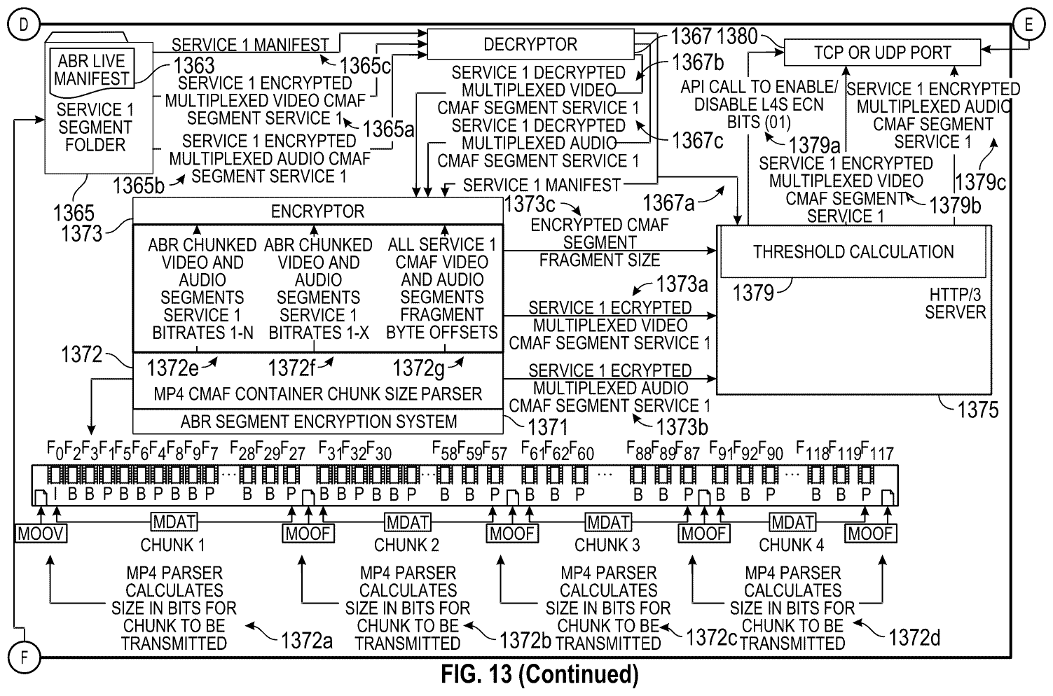

FIG. 4 depicts a system 400 including a CDN edge node 460, e.g., including a decryptor 467, and an ABR segment encryption system 471 including an encryptor 473, for low latency content delivery by tagging certain fragments for preferential processing, in accordance with some embodiments of the disclosure. Additional embodiments of the system 400 of FIG. 4 are provided with reference to FIG. 13 herein.

Embodiments are provided for OTT streaming. In some approaches, delivery of RTP ultralow latency is provided, which is enhanced for use cases like cloud gaming, cloud-based SLAM, remote vehicle control, or the like. However, it is noted that the delivery of OTT ABR segments herein is quite different than RTP streamed video and audio packets. The RTP system and methods do not work in the OTT ABR applications. As presented herein, systems and methods for optimizing delivery of segment data at a fragment level from a CDN edge node are provided.

HTTP-based OTT ABR streaming, also called HAS, has continued to increase as the demand for live content has increased. ABR formats, like Apple's HLS or MPEG Dynamic Adaptive Streaming over HTTP (DASH), which were originally designed for video-on-demand (VOD) streaming, are used but have been modified to support live content. Typically, devices that support Apple's HLS or MPEG DASH for live streams buffer plural (e.g., three) video segments. The plural segment buffering provides a full buffer for playout reliability, allows bandwidth measurement algorithms that run on the device to select which bitrate segments to receive, and adjusts the bitrate in time to prevent completely draining the buffer and stalling playout. Even though live content interaction does not necessarily need to be as low in latency as cloud-gaming (e.g., first-person shooter (FPS) games, remote control of a vehicle, or interactive XR experiences), the latency may need to be lower for these types of applications resulting in a much smaller buffer than three segments. In some cases, the latency must be less than the playout time of one segment. In interactive experiences with live content, MPEG DASH and HLS do not offer low latency for an interactive experience with the live content. Another example of an interactive experience is gambling and placing bets during live sporting events (e.g., bets like “Will the player make the goal?” require low latency for an optimal user experience).

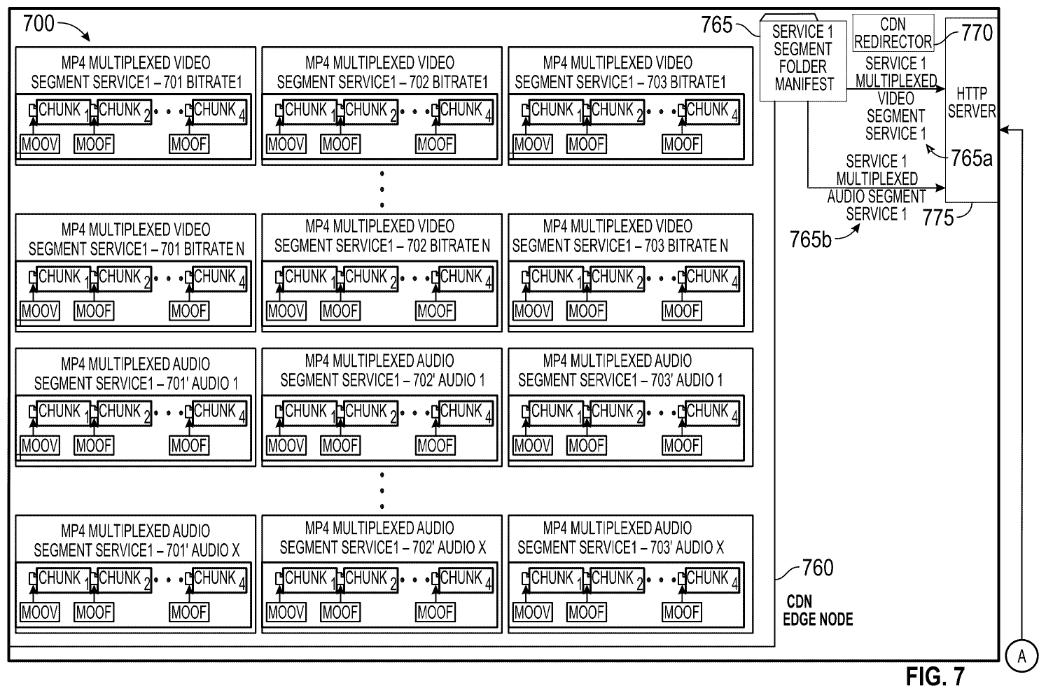

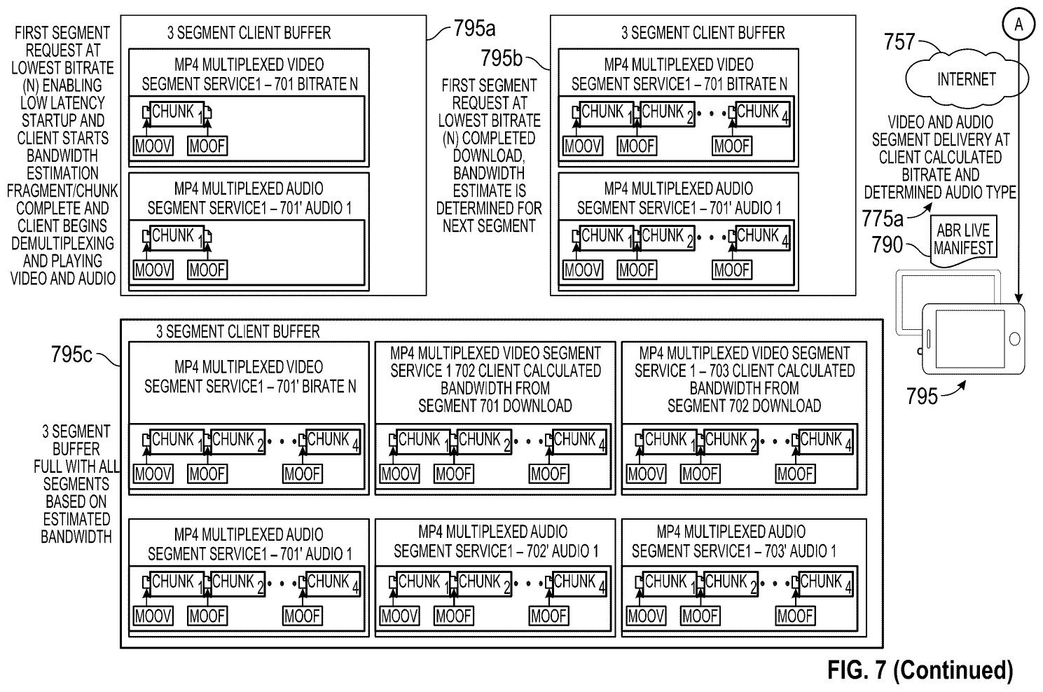

When video is encoded at a set bitrate, the encoder encodes the video to average out to a bitrate over time. For example, a defined buffer model achieves encoding the video to average out to the bitrate over time. Also, for example, a modeled buffer may be provided within a rate controller of an encoder. Video encoders can be configured to encode I-pictures, P-pictures, and B-pictures into a GOP structure. In many instances, the I-pictures, P-pictures, and B-pictures have varied sizes, where an I-picture is very large (e.g., greater than about 600 KB as shown, for example, in FIG. 2, or greater than about 60 KB as shown, for example, in FIG. 3) as compared to the P-pictures and B-pictures. Further, for example, P-pictures are often larger than B-pictures. The differences between one frame and the next also impacts the picture size. Some content is more difficult to encode versus other content based, on the differences from picture to picture. A news broadcast is typically easy to encode since the video is usually of a person or a few people sitting in front of a camera just talking. Still further, for example, a basketball game is more difficult to encode, because the difference from one picture to the next can be significant due to the movement of the camera, the movement of the players, and the movement of the people captured in the stands (other examples include rendering of grass on a football field during movement of a player in motion and moving water or waves). In cloud gaming, the difference in frames is also a big factor. Due to the extreme low latency requirement, an encoder is configured to encode an I-picture at the beginning, and every picture after the I-picture is a P-picture. B-pictures are not encoded in cloud gaming due to the increased latency. A GOP for typical video with no low latency requirement would typically be an encode order of (I,P,B,B,B) for encoding efficiency. The way the pictures are encoded is a sequence of (I, P, B, B, and B), meaning the encoder will have to encode the I-pictures, P-pictures, and B-pictures before delivering those pictures to the client device. In this example, the source device must render the pictures in the order of (I, B, B, B, and P) before the pictures are sent to the client device. As shown, for example, in FIG. 7, a decode/display order of I(1), B(2), B(3), P(4), B(5), B(6), and P(7) is shown versus an encode and multiplex order of I(1), P(4), B(2), B(3), P(7), B(5), and B(6). The client device, in this example, must wait on the P-picture to decode the B-pictures. To enable the lowest latency, an I-picture, P-picture (IP) GOP structure may be used. In the case of SLAM or remote-rendered gaming, there is typically one encoder per each client device or user device; there is no need to generate an instantaneous decoder refresh (IDR) frame (a type of I-frame that specifies that no frame after the IDR frame can reference any frame before it) every so often since no other client devices will need to join the video stream. In these cases, an IDR picture is created at the start of the video stream and all following pictures will be P-pictures. For HTTP ABR video, for example, an IDR must be the first picture of every segment.

Streaming for ultralow latency use-cases like cloud gaming, cloud-based SLAM, remote vehicle control, or the like (e.g., having a latency requirement of about 10 to about 100 milliseconds) typically uses RTP working in conjunction with RTCP. RTP streaming is a push model where the server streams the RTP packets to the client device over connectionless transport UDP. RTP is also the basis for Web Real-Time Communication (WebRTC) streaming and offers relatively low latency.

In various embodiments, HTTP adaptive streaming, OTT ABR streaming, and/or live streaming are provided. For example, in some approaches, low latency interactivity in OTT ABR streaming for OTT ABR interactivity based on OTT live content is provided. Also, encoding and client buffering optimization are provided. The present application provides systems and methods for an optimized delivery improving transport latency related to, for example, delivering offset segments.

OTT ABR Live streaming is a low latency use case (e.g., a latency requirement of about one second to about 10 seconds). For example, initial rendering latency or Fast Channel Change is provided (versus latency behind live). OTT ABR is a pull model where the client device requests segments for download over HTTP. The client device makes a request to a CDN system. The CDN redirects the client device to a CDN edge node where the segments are cached. The client device pulls the segments from the edge node. In prior approaches, for OTT ABR pulling of video and audio-based segments over HTTP/2, TCP is utilized. The present systems and methods provide, among other advantages, improved OTT ABR pulling of video and audio-based segments.

Since the MP4 container format was created as a format for file-based content, it needed improvements for use in ABR streaming. For example, in some approaches, the MP4 multiplexer had to complete the multiplexing of the segment before it could be placed on the CDN origin, distributed to the client devices, and made available for playout. This caused an increase in latency for initial playout of video. When a user was changing channels in an OTT environment, the rendering time of the video often contributed to a poor user experience. Multiplexing changes for MP4 (i.e., MPEG-4 Part 14) containers have been included in the MPEG standard for a multiplexing modification to the specification. The changes resulted in the CMAF format being added to the MPEG-4 Part 14 specification. This allows the multiplexer to include a new box called the movie fragment (MOOF) box into the multiplexed stream. As a result, the segment is subdivided into fragments. Each fragment is separated by a MOOF box. Also, the demultiplexer can demultiplex at the fragment level versus having to download the complete segment to begin playout.

In some embodiments, a system for delivering media content using the Common Media Application Format (CMAF) standard is provided. The system uses MP4 containers, which begin with a MOOV box followed by a media data box (MDAT) containing the payload. This payload is demultiplexed using information from a MOOF box. The system can include an ABR live encoder, an ABR packager, and a client device. The encoder sends bitstreams to the packager, which then sends fragmented video and audio segments to the client device. The CMAF standard allows for the delivery of media content in small fragments, each containing a few frames of video or audio. For example, about one frame per fragment may be provided. Also, for example, many frames up to an entire segment could be represented as a fragment. Further, for example, about one frame per fragment or many frames up to an entire segment within a fragment would behave about the same as a non-CMAF multiplexed segment. This approach is beneficial for live streaming scenarios as it enables faster delivery and playback of media, thereby reducing initial playout latency. The system also involves a CDN for content delivery. The CDN receives the multicast ABR segment video and audio fragment distribution and sends it to the CDN edge node. The CDN edge node then sends the video and audio segment delivery at the client-calculated bitrate and determined audio type to the client device. This system is particularly efficient for live streaming applications, speeding up channel change time and allowing for efficient use of network resources.

FIG. 5 shows an example of a container layout for CMAF-enabled fragmented segments. As shown across the top of FIG. 5, all MP4 containers begin with a MOOV box or atom. This is followed by the Media Data Box (MDAT), which contains the payload (in this case, video or audio packetized elementary streams (PES) encapsulated data) up to the first MOOF box. This MOOF box contains information to demultiplex the MDAT up until the MOOF box. Following the first MOOF box is the next MDAT data, which includes encapsulated PES data. This continues until an end of the segment. There is no limit on how many video frames must be included in a CMAF fragment. For example, the number of video frames could be anywhere from one video frame to an entire segment. The more MOOF boxes that are included, the more data is required for the segment; however, this additional overhead is relatively low compared to the added benefit of faster rendering of OTT content, which provides a better user experience for use cases like faster channel change and faster rendering when using trick modes in time-shifted television (TSTV). For CDN distribution, live content is pushed to the CDN edge nodes at the fragment level.

In some embodiments, a system 500 includes an ABR live encoder 515, an ABR packager 520, and a client device 595. For example, the ABR live encoder 515 sends ABR encoded bitstreams 515 to the ABR packager 520, which sends ABR fragmented video segments at bitrates 1 to n 520a and ABR fragmented audio segments 1 to x 520b (illustrated in detail in the center of FIG. 5), and an ABR live manifest 520c to an ABR live manifest storage 540. The CMAF standard allows for the delivery of media content in small fragments, each containing a few frames of video or audio. This approach is particularly beneficial for live streaming scenarios, as it enables faster delivery and playback of media, thereby reducing initial rendering latency. For example, FIG. 5 depicts a scenario in which media is delivered at a rate of 60 frames per second (fps), with each segment being about two seconds long. Each segment contains 120 frames of video. These frames are grouped into four MOOF boxes, each containing 30 frames. The segments are delivered to the client device 595, which tends to buffer three segments at a time. In this example, MP4 multiplexed video and audio segments are provided. Playout begins when the first fragment of segment 501 is received. The MP4 multiplexed video segment (e.g., 501, 502, 503) is the main video data for the segment. It contains a MOOV box followed by a series of MOOF boxes. The MOOV box contains metadata about the media, while each MOOF box contains a fragment of the actual media data or mdat. The fragments are delivered in sequence, with each fragment starting with an I-frame (keyframe) followed by a series of B-frames and P-frames. The MP4 Multiplexed audio segment (e.g., 501′, 502′, 503′) is the corresponding audio data for the segment. It is structured similarly to the video segment, with a MOOV box followed by a series of MOOF boxes containing the audio data fragments. The segments are encoded by the ABR live encoder 515, packaged by the ABR packager 520, and then distributed to a CDN edge node (see, e.g., FIGS. 1, 3, 4, 6, 7, and 11-13) for availability to the client device 595. The example of FIG. 5 assumes the segments are at the CDN edge node. An ABR live manifest 540 provides the client device 595 with information about the available bitrates and segments. (Similar to that described in subsequent FIGS., ABR live manifest is identified as ABR live manifest 590 on the client side.) This approach speeds up channel change time and allows for efficient use of network resources, making it a popular choice for live streaming applications.

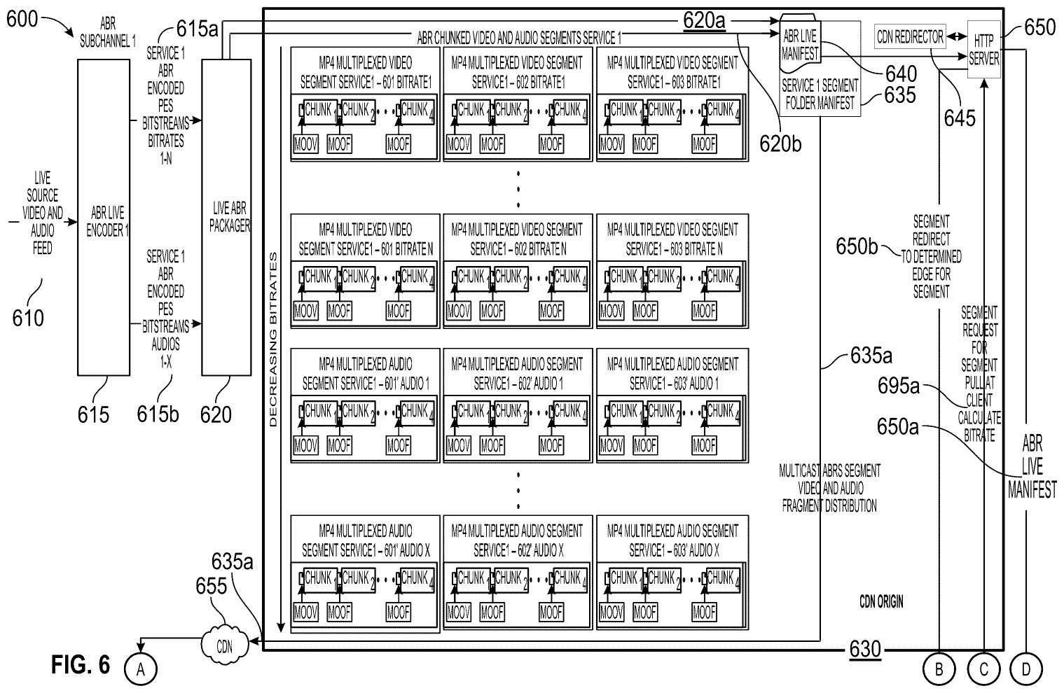

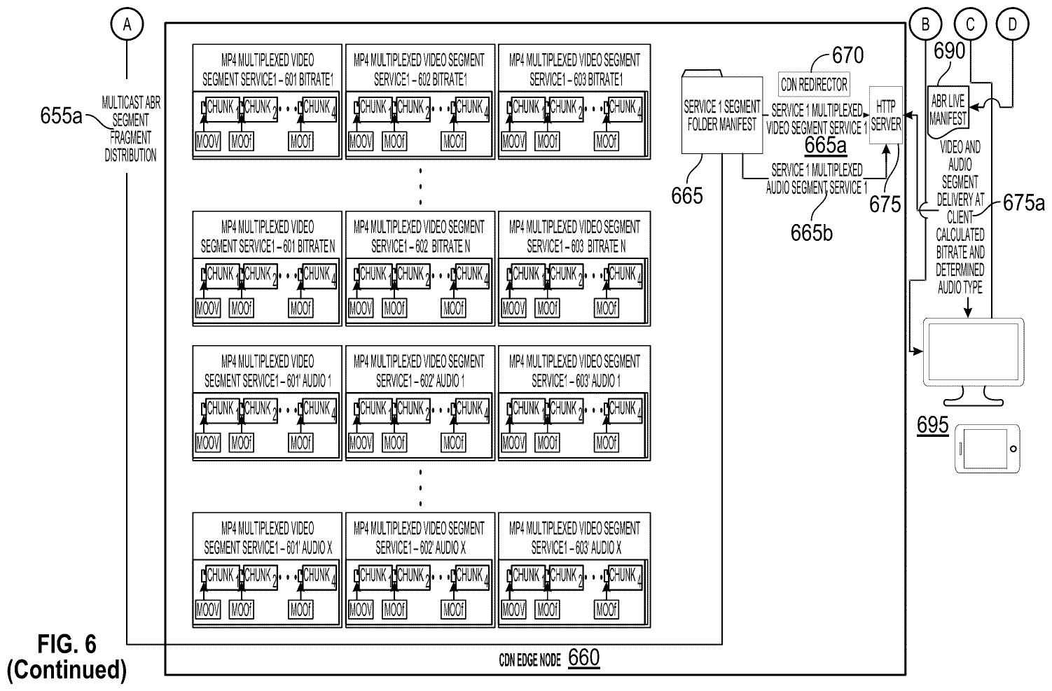

FIG. 6 shows a system 600 at a high level for a CDN. For example, content delivery is performed via multicast delivery from a CDN origin 630 to the edge nodes, e.g., CDN edge node 660, for all segments (versus caching the content as client devices pull the segments like in VOD). The packager (e.g., live ABR packager 620) updates the live manifest as the segments are created. A client device (e.g., 695) makes a request for the manifest (e.g. 650a) when a user decides to watch a live service. The live manifest (e.g., ABR live manifest 650a) is delivered to the client device. The client device requests a segment from the CDN (e.g., 655). Based on the client device's determined location, the CDN redirector (e.g., 670) will redirect the client device to the proper node to begin downloading the segment. This is an ongoing process where the client devices continue to receive manifest updates and the client device will continue to request segments until the service is terminated at the client device (e.g., by operation of a user). The client device will continue to estimate bandwidth and decide which segment to request based on the client device's estimated bandwidth. In this example, bitrate n is the lowest bitrate.

In some embodiments, segments are created in fragments and are part of the MP4 multiplexed video and audio segments for service 1 at different bitrates and audio types (e.g., video segment 601 at bitrate 1, video segment 602 at bitrate 1, and video segment 603 at bitrate 1 . . . video segment 601 at bitrate n, video segment 602 at bitrate n, and video segment 603 at bitrate n; and audio segment 601′ of audio 1, audio segment 602′ of audio 1, and audio segment 603′ of audio 1 . . . audio segment 601′ of audio n, audio segment 602′ of audio n, and audio segment 603′ of audio n). The fragments are part of the MOOV and MOOF structures in the MP4 file format.

In some embodiments, a live source video and audio feed 610 is received at an ABR live encoder 1 615 on ABR subchannel 1. For example, the ABR live encoder 1 615 sends service 1 ABR encoded PES bitstreams at bitrates 1-n 615a and service 1 ABR encoded PES bitstreams for audio 1-x 615b to a live ABR packager 620. Also, for example, the live ABR packager 620 sends ABR fragmented video segments for service 1 620a and ABR fragmented audio segments for service 1 620b to the CDN origin 630. Further, for example, the ABR fragmented video segments for service 1 620a and the ABR fragmented audio segments for service 1 620b are received as an ABR live manifest 640 in a service 1 segment folder 635 of the CDN origin 630. Still further, for example, a multicast ABR segment video and audio fragment distribution 635a is sent from the service 1 segment folder 635 to the CDN 655. Moreover, for example, the ABR live manifest 640 is sent to an HTTP server 650. In addition, for example, a CDN redirector 645 controls the HTTP server 650. Furthermore, for example, the HTTP server 650 sends an ABR live manifest 650a to an ABR live manifest storage 690 of the client device 695. Additionally, for example, based at least in part on a segment request for segment pull at client-calculated bitrate 695a from the client device 695, a segment redirect to a determined edge node for a segment 650b is sent to the client device 695.

In some embodiments, the CDN 655 receives the multicast ABR segment video and audio fragment distribution 635a and sends a multicast ABR segment's fragment distribution 655a to the CDN edge node 660.

In some embodiments, the CDN edge node 660 receives the multicast ABR segment's fragment distribution 655a. For example, a service 1 segment folder 665 of the CDN edge node 660 receives the multicast ABR segment's fragment distribution 655a. Also, for example, service 1 multiplexed video segment service 1 665a and service 1 multiplexed audio segment service 1 665b are sent to HTTP server 675. Further, for example, a CDN redirector 670 of the CDN edge node 660 controls the HTTP server 675. Still further, for example, video and audio segment delivery at client-calculated bitrate and determined audio type are sent and/or received between the HTTP server 675 and the client device 695.

In some embodiments, a system for live streaming services that optimizes the initial buffer fill and playback speed is provided. When a user selects a live service, the client device requests the manifest and then the lowest bitrate video segment and the appropriate audio segment. The client device is redirected to the CDN edge node, and the audio and video segments are delivered to the client device. The client device starts its bandwidth estimate calculation and continues to download the first segment while calculating its available bandwidth. Once the first segment has downloaded, the client device requests the next segment for download based on the estimated bitrate. This process is repeated for features such as trick play or time-shifted television (TSTV) rewinding of live content.

The system also includes improved congestion control and selective Low Latency, Low Loss, Scalable throughput (L4S) features. Many internet applications are queue-building, meaning they use buffering in the network and at the receiver. Congestion control is built into these applications at the transport layer. However, traditional congestion-control mechanisms can introduce latency, jitter, and packet loss. With LAS, network service providers have introduced dual queueing in their network. Some traffic in need of low latency may use a low latency queue. L4S enablement on a packet occurs by marking the explicit congestion notification (ECN) bits in the packet header.

Also provided is a table representing the marking of an ECN packet and examples of ranges of latencies for various types of applications and/or protocols. The latency ranges from high latency (about 45 seconds or more) to near-real-time latency (less than about 100 milliseconds). Different applications fall within these ranges based on their latency requirements.

A client device's buffer is shown in FIG. 7 over the course of initial buffer fill. When a user selects to watch a live service, the client device (e.g., 795) requests the manifest (e.g., ABR live manifest 790). Once the manifest is received, as observed in Hulu and other live services, for the fastest initial playout, the client device requests the lowest bitrate in the manifest for the video segment and requests the proper audio segment based on surround sound, audio language, or the like (e.g., at 795a). The client is redirected to the CDN edge node (e.g., 760), and the audio and video segments are delivered to the client device (e.g., at 775a). The client device starts its bandwidth estimate calculation (e.g., at 775b). As soon as the first fragment for audio and video are received in the first requested segments, the client device demultiplexes the CMAF fragments and the video and audio PES streams are sent to the video and audio decoders and rendered on the client device. The client continues to download the first segment while calculating its available bandwidth. In some embodiments, once the first segment has completed downloading, the client device requests the next segment for download based on the estimated bitrate based on the segment bitrates available in the bitrate ladder represented in the manifest (e.g., at 775b). For example, a three segment buffer stores three segments of the content based on the estimated bandwidth (e.g., at 795c). For each segment that is downloaded, bandwidth calculation is performed, and the client device will adjust requested bitrates from the bitrate ladder. If, at the client device, e.g., via selection of an operation, the user decides to use a feature such as trick play or TSTV rewinding of live content and moves to a frame outside of the buffered content, in some embodiments, this exact process is performed to enable as fast as possible initial rendering of the content. Also, for example, in some embodiments, a request of a second segment is made before a complete download of a previous segment. Further, for example, in some embodiments, the client requests the next segment for download based on a bandwidth estimation and bitrates indicated in a manifest.

As described in detail herein, for example, one or more of the example of CMAF-enabled MP4 multiplexing with segments subdivided into fragments (e.g., FIG. 5), live fragment distribution from a CDN origin for precaching at edge nodes leveraging multicast distribution (e.g., FIG. 6), and a client device initially requesting live service 1, in accordance with some embodiments of the disclosure (e.g., FIG. 7) is provided with improved congestion control and selective L4S features.

Regarding L4S, many of the internet applications we use every day are queue-building, i.e., they use buffering in the network and at the receiver. Since the sender is trying to estimate and/or infer the carrying capacity of the network at any time, congestion control is built into such buffer-dependent applications at the transport layer. Thus, applications are constantly adjusting their sending rates, aiming to send as fast as they can and backing off only when they detect congestion. However, congestion-control mechanisms have not evolved significantly since the early days of the internet in the mid-1980s. Algorithms, such as TCP Tahoe, Reno, Vegas, CUBIC, Prague, and the like rely on the network to provide deep packet buffers and then drop packets when the buffers overflow. The algorithm ramps up, causes delay and packet loss, backs off and ramps up again. Thus, these mechanisms can introduce latency, jitter and packet loss—not only to themselves but also to other applications using the network at the same time.

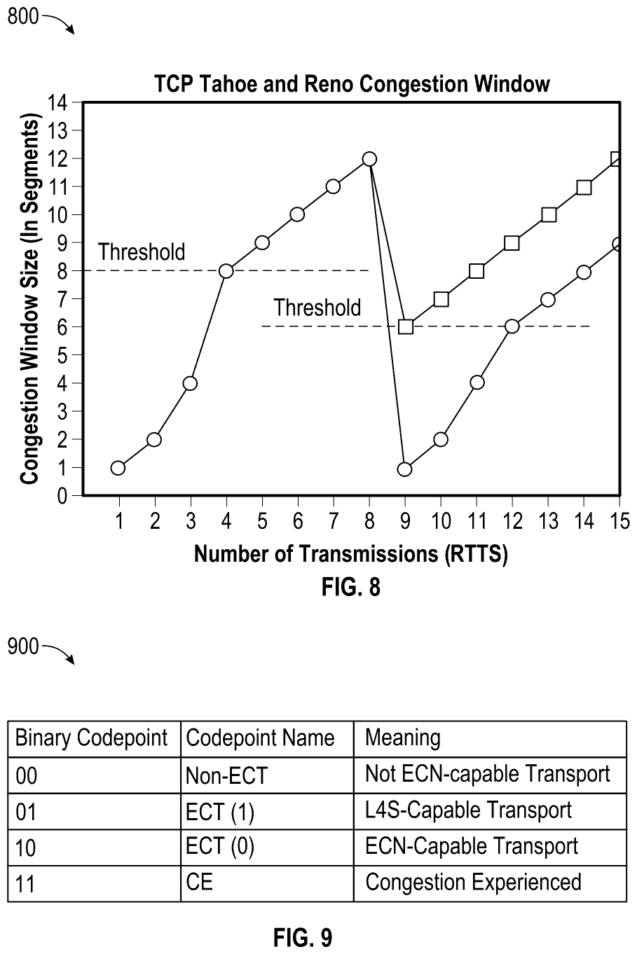

Congestion control involves setting a sender window that is the minimum value between a receiver's advertised window (based on receiver's buffer) and an inference of the network's ability to transport packets, i.e., the congestion window. The congestion window (CWND) is a TCP state variable that limits the amount of data the TCP can send into the network before receiving an acknowledgment (ACK). A congestion window allows the sender to have at most CWND unacknowledged bytes at any given time, effectively controlling the rate at which data is sent. FIG. 8 illustrates how the congestion window changes in response to receiving acknowledgements that the receiver (over several RTTs) has correctly received a packet, or by a sender inference that a packet has been lost (either timeout, or duplicate ACKs when packets are received out of order). As shown in FIG. 8, a packet is determined to have been lost at the 9th RTT via reception of three duplicate ACKs at the sender.

With L4S, network service providers have introduced dual queueing in their network. While most queue-building traffic passes through a regular or default queue, some traffic in need of low latency may use a low latency queue. This “priority lane” is typically expected to be used by ultralow latency, non-queue-building traffic. However, other applications (including queue-building applications) also benefit from this queue when used selectively. As detailed herein, dynamic methods are provided for OTT ABR live streaming sender including selective enablement of L4S to improve throughput under various conditions.

L4S enablement on a packet occurs, for example, by marking the ECN bits in the packet IPIP header. FIG. 9 depicts a table 900 representing marking of an ECN packet, in accordance with some embodiments of the disclosure. For example, a packet is marked with codepoint name ECN-capable transport (ECT)(1) using a binary codepoint setting of 01 to identify the packet as LAS-capable transport. FIG. 9 contains information on ECN in computer networking. An ECN-capable AQM marks a packet as congestion experienced (CE) instead of dropping it when congestion is detected. This leads to a considerable reduction in packet loss but a less significant latency reduction compared to a packet-dropping AQM. LAS is an evolution of ECN. It dedicates one of the ECN codepoints, ECT(1), specifically for L4S traffic. The table 900 in FIG. 9 lists binary codepoints for ECN as follows:

| | | |
|---|---|---|
| 00: | Non-ECT | Not ECN-capable transport, |
| 01: | ECT(1) | L4S-capable transport, |
| 10: | ECT(0) | ECN-capable transport, and |
| 11: | CE | Congestion Experienced. |

For example, if a network element experiences congestion, it converts the 2-bit ECN marking from ECT(1) to CE. The markings are echoed back to the sender in acknowledgements from the receiver. The sender is then required to reduce throughput in scalable manner.

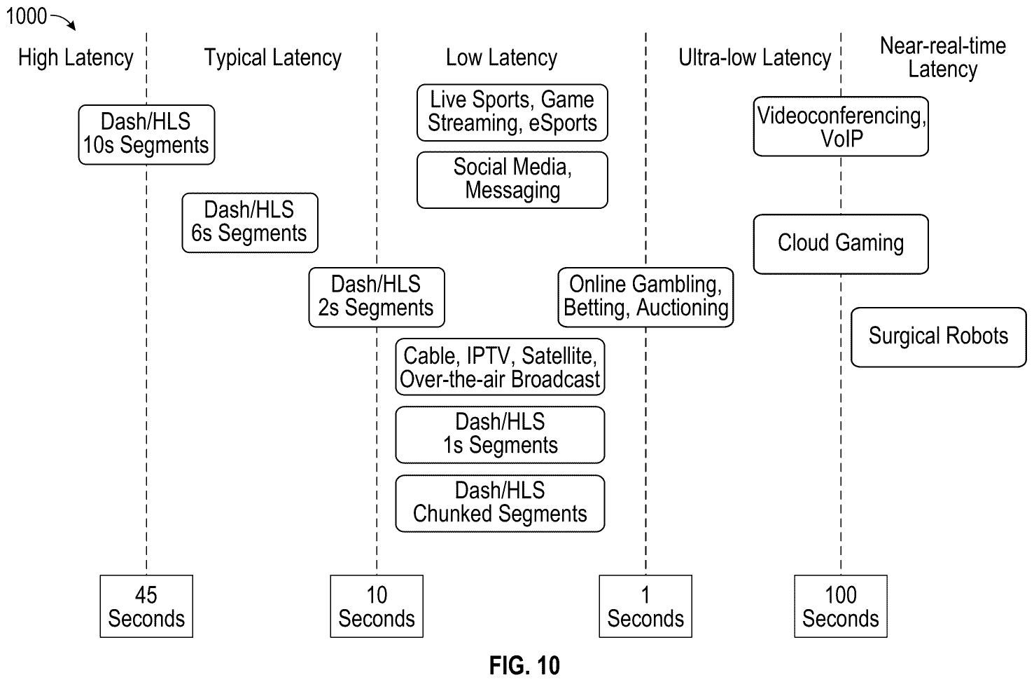

FIG. 10 depicts examples of ranges of latencies for various types of applications and/or protocols. It is to be understood that various terms relating toto latency may be understood as set forth in the following. These latency terms are not intended to be limiting but exemplary. “High” latency is, e.g., about 45 seconds or more. An example of this is DASH/HLS with 10-second segments. “Typical” latency ranges, e.g., from about 10 to about 45 seconds. This can be seen in DASH/HLS with 6-second segments. DASH/HLS with 2-second segments falls between low latency and typical latency. “Low” latency is, e.g., between about 1 and 10 seconds. Examples include DASH/HLS with fragmented or 1-second segments, cable, IPTV, satellite, over-the-air broadcast, social media, messaging, live sports, game streaming, and eSports. Online gambling, betting, and auctioning fall between ultralow latency and low latency. “Ultralow” latency is, e.g., about 100 milliseconds to about 1 second. Cloud gaming, videoconferencing, and Voice over IP (VOIP) straddle the line between near-real-time latency and ultralow latency. “Near-real-time” latency is, e.g., less than about 100 milliseconds. An example of this is surgical robots. An example of this is surgical robots.

In some embodiments, QUIC communication is provided. For example, for OTT ABR live streaming the QUIC protocol has started to replace TCP due to its many advantages. Also, for example, HTTP/3 is built using QUIC as its transport mechanism. Some of the advantages of QUIC over TCP include reduced connection establishment latency, multiplexing, connection migration, improved security, and wide support. Re reduced connection establishment latency, QUIC minimizes the latency by combining the TLS handshake with the connection setup. This is also known as zero round trip time (0-RTT). It results in faster connection establishment and improves performance of web applications. With multiplexing, QUIC can send multiple streams of data over a single channel. It greatly helps client applications which download multiple files, i.e., images, JavaScript, cascading style sheets (CSS), or the like. Re connection migration, using QUIC, it is possible to switch from one network interface to another (Wi-Fi to mobile data) without any glitch. This is useful for mobile devices and improves the user experience. Re improved security, QUIC works on TLS 1.3, which offers better security. Additionally, it also encrypts large parts of the protocol unlike TCP with TLS, which encrypts only the HTTP payload. It is more resilient to security attacks as compared to TCP. Re wide support, QUIC has seen a rise in adoption since its inception. This has further strengthened its effectiveness.

In some approaches, L4S transport may be selectively enabled to improve the performance of ultralow latency streaming. For example, L4S enablement of packets reduces RTT latency and often also packet loss. Also, for example, when an encoder produces a PES packet for one or more frames that is/are larger or much larger than a threshold, the sender invokes L4S via packet markings (e.g., ECN bits). Further, for example, using L4S, instantaneous throughput for a few packets that represent a frame is improved over RTP due to lower RTT latency on the L4S path and reduced packet loss on the L4S path. The instantaneous throughput improvement for RTP is observed over milliseconds or tens of milliseconds. For OTT ABR live streaming, however, as is explained herein, selective enablement of L4S uses a different underlying principle (e.g., a size of fragments for OTT ABR versus a size of a frame in PES for RTP). The throughput improvement is thus observed over several hundreds of milliseconds to seconds, which is a meaningful advantage in OTT ABR. Still further, for example, the frame may be so large that it requires multiple PES packets. In this example, a PES packet is much larger than an RTP or TCP packet. That is, in this example, many RTP or TCP packets are required to transmit a picture, especially for an Intra-picture or a P-picture or a B-picture after a scene change.

As noted in detail below with reference to FIG. 11, a system is provided that that optimizes the delivery of CMAF fragments in an OTT CDN. It enhances the initial rendering time for live streams and prevents bitrate drop in ABR client devices. The live stream is transcoded and packaged into MP4 CMAF segments, each fragmented based on a defined number of frames. The live ABR manifest, updated with new live fragments of segments, is sent to CDN edge nodes. When a client device requests a segment, a parser determines the fragment size and the requested bitrate. A threshold calculation system then determines a threshold size based on these parameters. The parser enables or disables the L4S markings accordingly for transport packets delivery to the client device. An encryption system allows parsing of the multiplexed segment to determine byte offsets for the CMAF fragments.

In some embodiments, OTT CDN delivery of CMAF fragments is optimized. For example, as shown in FIG. 11, a system 1100 for an OTT ABR system includes optimized delivery for CMAF fragmented segments based on a quantification, e.g., fragment size. The system 1100 speeds up initial rendering time for rendering a live stream on a channel change. The system 1100 also speeds up the initial rendering when a user time shifts live TV when the time shift is beyond the current playing live segment. Additionally, the system 1100 provides an optimization for delivery of large fragments and prevents the ABR client device from dropping the bitrate when the client device is close to its threshold of calculated bitrate change when deciding to move to a lower quality in its bitrate ladder due to a drop in bandwidth. The present inventors have investigated how ABR clients behave, and it has been observed that these client devices will adjust bitrate lower when the calculated network bitrate is about 85% of the represented bitrate in the manifest bitrate ladder.

In some embodiments, in the system 1100, a live stream (e.g., live source service 1 video and audio feed 1110) is received from a broadcaster over a satellite link (e.g., satellite (downlink) receiver 1105) or via a high-speed dedicated network link (not shown). For example, the live stream is delivered to a transcoder (e.g., ABR transcoder service 1 1115), which transcodes the incoming video source into encoded streams (e.g., service 1 ABR encoded PES bitstreams of video at bitrates 1-n 1115a and service 1 ABR encoded PES bitstreams of audio 1-x 1115b) based on a series of bitrates to be represented in the ABR segments. Also, for example, the ABR encoder feeds the ABR encoded streams to a live packager (e.g., live ABR CMAF packager service 1 1120). Further, for example, the live ABR CMAF compatible packager is configured to generate a series of MP4 CMAF segments, and each CMAF segment is fragmented based on a defined number of frames per fragment for all encoded ABR streams in the bitrate ladder and all audio encodings based on audio languages, formats, or the like (e.g., service 1 encrypted ABR encoded PES bitstreams of video at bitrates 1-n 1120a and service 1 encrypted ABR encoded PES bitstreams of audio 1-x 1120b). Still further, for example, the live CMAF packager generates and updates a live ABR manifest based on the new live fragments of segments being generated. In some approaches, the manifest is not usually distributed to the CDN edge node. In the system 1100, for example, the manifest is also sent to the CDN edge nodes (e.g., 1160) and updated at all edge nodes along with the segments. Moreover, in the system 1100, all the methods are implemented within each edge delivery node.

In some embodiments, a client device (e.g., 1195) requests a segment from an edge node (e.g., 1160). For example, as an MP4 segment to be delivered to the client is being read from storage to delivery to the client device by a transmitter (e.g., HTTP/3 server 1175 with QUIC), a parser (e.g., MP4 CMAF container fragment size parser 1177) parses the multiplexed file to determine fragment size for each fragment to deliver. As shown in FIG. 11, the parsing for the first fragment in the segment is from the MOOV box at the start of the segment to the first MOOF box in the segment (e.g., at 1177a). Also, for example, all subsequent parsing is from the previous MOOF box to the next MOOF box for the preceding fragment until the end of the segment (e.g., at 1177b, 1177c, and 1177d). Further, for example, the parser also receives the live manifest updates and reads the manifest (e.g., 1165c) for the client device to determine the segment's requested bitrate (e.g., 1177f) based on the segment requested by the client device. Still further, for example, the parser sends the requested CMAF segment's fragment size (e.g., 1177e) and the segment's requested bitrate (e.g., 1177f) to a threshold calculation system (e.g., 1179).

In some embodiments, as detailed in the example processes provided herein, the threshold calculation system (e.g., 1179) determines a threshold size (e.g., calculated threshold 1179a) based at least in part on the segment's requested bitrate (e.g., 1177f) and the size of the CMAF segment's fragment size (e.g., 1177e), which is the next fragment to deliver to the requesting client device. For example, the threshold calculation system sends the calculated threshold for that fragment to the MP4 CMAF container fragment size parser. Also, for example, the MP4 CMAF container fragment size parser enables or disables the L4S markings by sending the TCP or UDP port (e.g., 1180) a flag to either set or not set the ECN bits for all transport packets for each MP4 fragment to deliver to the client device (e.g., at 1177g). Further, for example, in the system 1100, an encryption system (e.g., segment encryption system 1125 with MOOV and MOOF MP4 boxes metadata in the clear) leaves the MOOV and MOOF MP4 boxes allowing for the MP4 parser to parse the multiplexed segment to determine the byte offsets for the CMAF fragments to determine the size of each fragment.

In some embodiments, systems and processes are provided for managing encryption and delivery of video and audio segments in a content delivery network (CDN). For example, a system (e.g., 1100) sends MOOV and MOOF MP4 boxes in the clear, while another system (e.g., 1200) includes an ABR segment encryption system with an MP4 CMAF container fragment size parser. The HTTP/3 server reads the manifest and byte offsets to determine the bitrate and size of the requested segment. Also, a system (e.g., 1300) controls encrypted fragments when MOOV and MOOF boxes are sent encrypted, involving decryption to read these boxes and determine fragment sizes. Further, a process (e.g., 1400) is for CDN distribution with MOOV and MOOF in the clear or edge node decrypting and encrypting during delivery, including receiving a live service broadcast feed, transcoding it into multiple quality video streams and audio streams, sending these to a live ABR packager, encrypting a segment's fragment with one or more encryption key(s) leaving the MOOV and MOOF boxes in the clear, and writing the CMAF segment CMAF fragment to the CDN origin. The process (e.g., 1400) also includes updating a segment folder and a live manifest with the latest CMAF live segment's fragment to the CDN origin server and distributing the manifest and the segment's fragment to the CDN edge nodes. These systems and processes optimize encryption, parsing, and delivery of video and audio segments in a CDN, ensuring efficient and secure delivery of content to client devices.

As noted above, the system 1100 includes sending the MOOV and MOOF MP4 boxes in the clear for parsing the MP4 multiplexed stream to determine the size of each fragment. This may not be desired. In some embodiments, a modified system 1200 is provided, which is shown in FIG. 12. In the system 1200, for example, an ABR segment encryption system (e.g., 1225) includes an MP4 CMAF container fragment size parser (e.g., 1227). Also, for example, the MP4 CMAF container fragment size parser parses the live MP4 CMAF multiplexed fragments as they are produced for the segment that is currently being generated. Further, for example, the MP4 CMAF fragment size parser sends the byte offsets for each of the fragments received from the packager (e.g., 1220) for the segments for the bitrate ladder. These byte offsets are saved into a metadata file including all CMAF video and audio segments (e.g., at 1237). This metadata file is distributed to each CDN delivery node cache along with the ABR fragments for the segment being produced and the live manifest. When a client device requests the segments from the delivery node, the HTTP/3 server (e.g., 1275) reads the requested segment file from the edge node cache data store. The HTTP/3 server also receives the updates to the live manifest from the delivery node cache. When a fragment is about to be delivered to the client device, the threshold calculation system (e.g., 1279) in the HTTP/3 server reads the manifest (e.g., 1276) for the segment to be delivered to the client device to determine the bitrate of the requested segment. The threshold calculation system reads the byte offsets for the current fragment to be delivered and determines the size of the fragment.

In some embodiments, based at least in part on one or more features of one or more methods provided herein, the threshold calculation system determines a threshold size based on the requested segment bitrate (e.g., 1279a) and the size of the CMAF segment's fragment and/or fragment size, which is the next fragment to deliver to the requesting client device. The HTTP/3 server enables or disables the L4S markings by sending the TCP or UDP port (e.g., 1280) a flag to either set or not set the ECN bits for all transport packets for each MP4 fragment to deliver to the client device (e.g., at 1279a). In some embodiments, the parsing is performed outside of the encryption system (e.g., 1229), and the fragment byte offsets are sent directly to the HTTP server. This byte offset file (e.g., 1237) continues to be updated like the manifest (e.g., 1240). The byte offsets in the metadata file are maintained back to the start of the live service until the end of the live service. For example, these byte offsets are also maintained with the live asset if the client device receives user selection to record the content in the OTT ABR network PVR system.

The systems 1100 and 1200, for example, handle encryption in two different approaches for determining the byte offsets. In some embodiments, FIG. 13 depicts a system 1300 for controlling the encrypted fragments when the MOOV and MOOF boxes are sent encrypted. For example, the segments are encoded, packaged and delivered to the CDN origin (e.g., 1330), which is one approach. As in FIGS. 11 and 12, the manifest file is sent to the edge nodes, and it is updated based on the live segment generation continuing throughout the live service. When a client makes requests for segments, the fragments need to be parsed to determine the byte offsets. This involves decrypting a segment to read the MOOV and MOOF boxes to determine the fragment sizes. A decryptor (e.g., 1367) receives the manifest (e.g., 1365c) to access the encryption key information. The decryptor reads the video and audio segment data and sends the decrypted audio and video segment files (e.g., at 1367b and 1367c) to an encryptor (e.g., 1373). In the encryptor, the MP4 CMAF container fragment size parser (e.g., 1372) parses the audio and video segments to determine the size of the segment's fragments by the number of bytes between the MOOV and 1st MOOF (e.g., at 1372a) or the MOOF boxes to determine the fragment sizes in the segment to deliver. The encryption system sends the live service encrypted audio and video segments (e.g., at 1373a and 1373b) to the HTTP/3 server (e.g., 1375) to be delivered to the client device (e.g., 1395). The encrypted CMAF segment's fragment size (e.g., 1373c) is sent to the HTTP/3 server's threshold calculation system (e.g., 1379). Based at least in part on the segment bitrate requested in the manifest and the size of the encrypted CMAF fragment, the HTTP/3 server enables or disables the L4S ECT settings (01) for all packets for the delivery of the packets for the fragment (e.g., at 1379a).

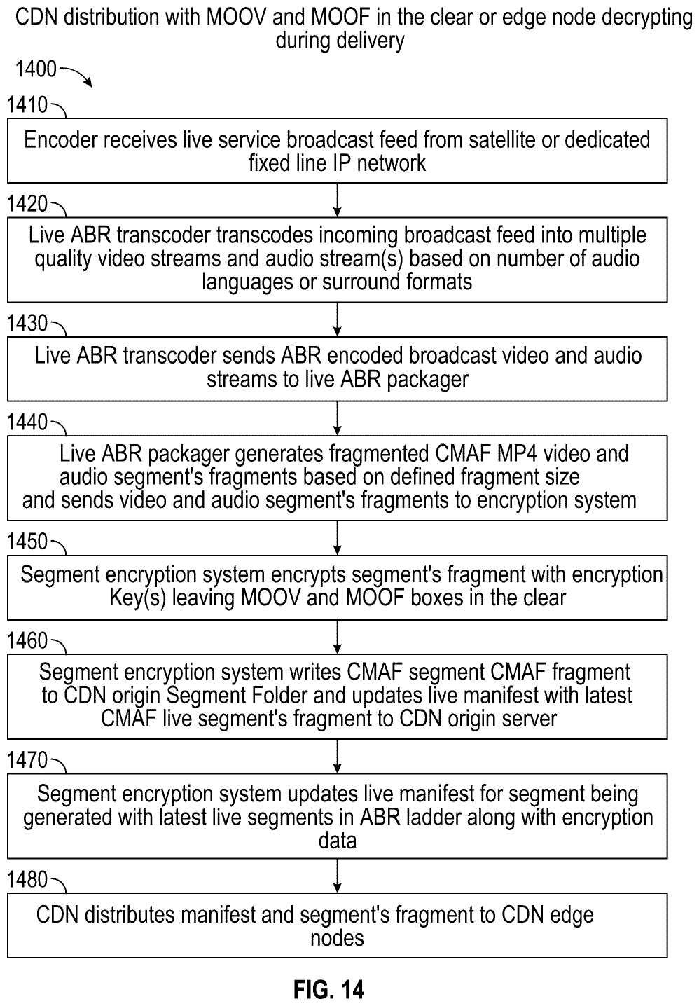

FIG. 14 depicts an example process 1400 for creating CMAF segment's fragments (e.g., for the devices and systems shown in FIGS. 1, 4, 11 and 13), in accordance with some embodiments of the disclosure. For example, the process 1400 is for CDN distribution with MOOV and MOOF in the clear or edge node decrypting and encrypting during delivery. Also, for example, the process 1400 includes receiving 1410, at an encoder, a live service broadcast feed from a satellite or dedicated fixed line IP network. Further, for example, the process 1400 includes transcoding 1420, at a live ABR transcoder, an incoming broadcast feed into multiple quality video streams and audio stream(s) based on a number of audio languages or surround formats. Still further, the process 1400 includes sending 1430, from the live ABR transcoder, ABR encoded broadcast video and audio streams to a live ABR packager. Moreover, the process 1400 includes generating 1440, at the live ABR packager, fragmented CMAF MP4 video and audio segment's fragments based at least in part on a defined fragment size and sending the video and audio segment's fragment to an encryption system. In addition, the process 1400 includes encrypting 1450, at a segment encryption system, a segment's fragment with one or more encryption key(s) leaving the MOOV and MOOF boxes in the clear. Furthermore, the process 1400 includes writing, at the segment encryption system, the CMAF segment CMAF fragment to the CDN origin. Additionally, for example, the process 1400 includes updating 1460 a segment folder and updating a live manifest with a latest CMAF live segment's fragment to the CDN origin server. Further still, for example, the process 1400 includes updating 1470, at the segment encryption system, the live manifest for the segment being generated with latest live segments in an ABR ladder along with encryption data. Even further, for example, the process 1400 includes distributing 1480, at a CDN, the manifest and the segment's fragment to the CDN edge nodes.

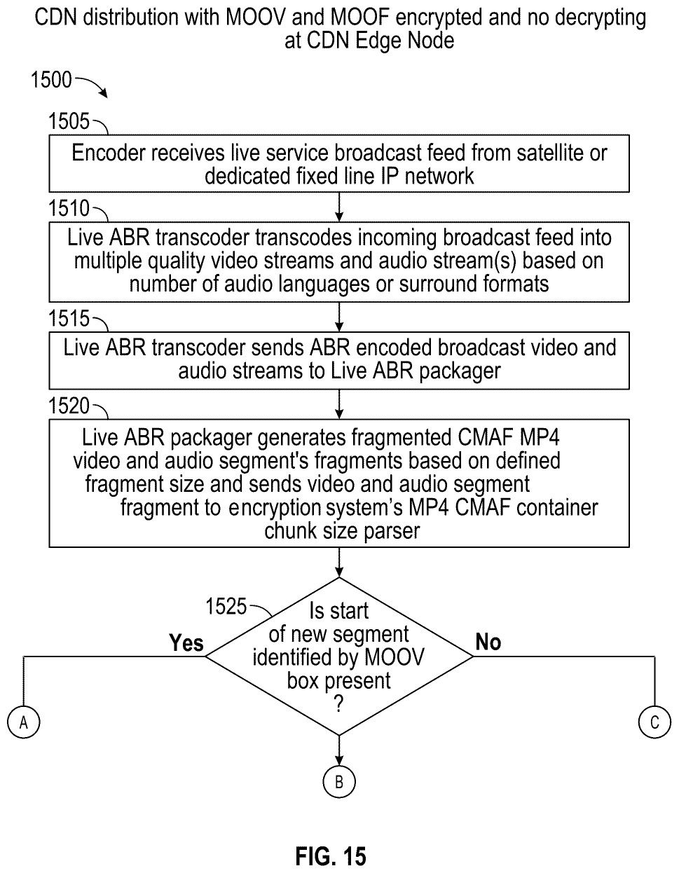

In some embodiments, a process (e.g., 1500 as depicted in FIG. 15) includes creating CMAF segment's fragments for efficient and secure delivery of live video and audio content to end-users. This involves CDN distribution with MOOV and MOOF encrypted, and no decrypting and encrypting at the CDN edge node. The process includes receiving a live service broadcast feed, transcoding the feed into multiple quality video and audio streams, sending these streams to a live ABR packager, and generating fragmented CMAF MP4 video and audio segment's fragments. These fragments are then sent to a segment encryption system. Depending on whether a new segment is identified by a present MOOV box, the segment is parsed differently and sent to an encryptor. The segment's fragment is then encrypted and written to a CDN origin segment folder, and the live manifest is updated with the latest live segments and encryption data. Finally, the CMAF video and audio segments, fragment byte offsets metadata file, manifest, and the segment's fragment are distributed to one or more CDN edge nodes.

FIG. 15 depicts an example process 1500 for creating CMAF segment's fragments (e.g., for the devices and systems shown in FIGS. 3 and 12), in accordance with some embodiments of the disclosure. For example, the process 1500 involves CDN distribution with MOOV and MOOF encrypted and no decrypting and encrypting at the CDN edge node. In some embodiments, the process 1500 ensures efficient and secure delivery of live video and audio content to end-users. For example, the use of encryption and fragmenting allows for better performance and security. The CDN edge nodes, for example, distribute the content, making it accessible to users around the world with minimal latency. The MOOV and MOOF boxes are, for example, part of the MP4 file structure and are used to identify the start of a new segment.

For example, the process 1500 includes receiving 1505, e.g., at an encoder, a live service broadcast feed from a satellite or dedicated fixed line IP network. Also, for example, the process 1500 includes transcoding 1510, e.g., at an ABR transcoder, the incoming broadcast feed into multiple quality video streams and audio streams based on the number of audio languages or surround formats. Further, for example, the process 1500 includes sending 1515, e.g., at a live ABR transcoder, the ABR encoded broadcast video and audio streams to, e.g., a live ABR packager. Still further, for example, the process 1500 includes generating 1520, at the live ABR packager, fragmented CMAF MP4 video and audio segment's fragments based on a defined fragment size and sends the video and audio segments to a segment encryption system. Moreover, for example, the process 1500 includes determining 1525 whether a start of a new segment is identified by a present MOOV box. In addition, for example, the process 1500 includes, based at least in part on determining the start of the new segment is not identified by the present MOOV box (1525=“No”), parsing 1530 the segment by counting the bytes from previous MOOF box to the latest MOOF box for all segment bitrates for the video and all audio languages/types and sends the byte size for all fragments video and audio segment's fragments to an encryptor. Furthermore, for example, the process 1500 includes, based at least in part on determining the start of the new segment is identified by the present MOOV box (1525=“Yes”), parsing 1535 the segment by counting the bytes from MOOV box to the first MOOF box or all segment bitrates for the video and all audio languages/types and sends the byte size for all fragments, video and audio segment's fragments to the encryptor.

For example, the process 1500 includes encrypting 1540 the segment's fragment with encryption keys and writing the CMAF segment's fragment to, e.g., a CDN origin segment folder. Also, for example, the process 1500 includes updating 1545, e.g., at a segment encryption system, the CMAF video and audio segment's fragment byte offsets and fragment size metadata file for the segment's fragment to, e.g., the CDN origin segment folder. Further, for example, the process 1500 includes writing 1550, e.g., at the segment encryption system, the CMAF segment CMAF fragment to the CDN origin segment folder and updating the live manifest with the latest CMAF live segment's fragment to the CDN origin server. Still further, for example, the process 1500 includes updating 1555, e.g., at the segment encryption system, the live manifest for the segment being generated with the latest live segments in the ABR ladder along with the encryption data. Moreover, for example, the process 1500 includes distributing 1560, e.g., at the CDN, the CMAF video and audio segment's fragment byte offsets metadata file, manifest, and the segment's fragment to, e.g., one or more CDN edge nodes.

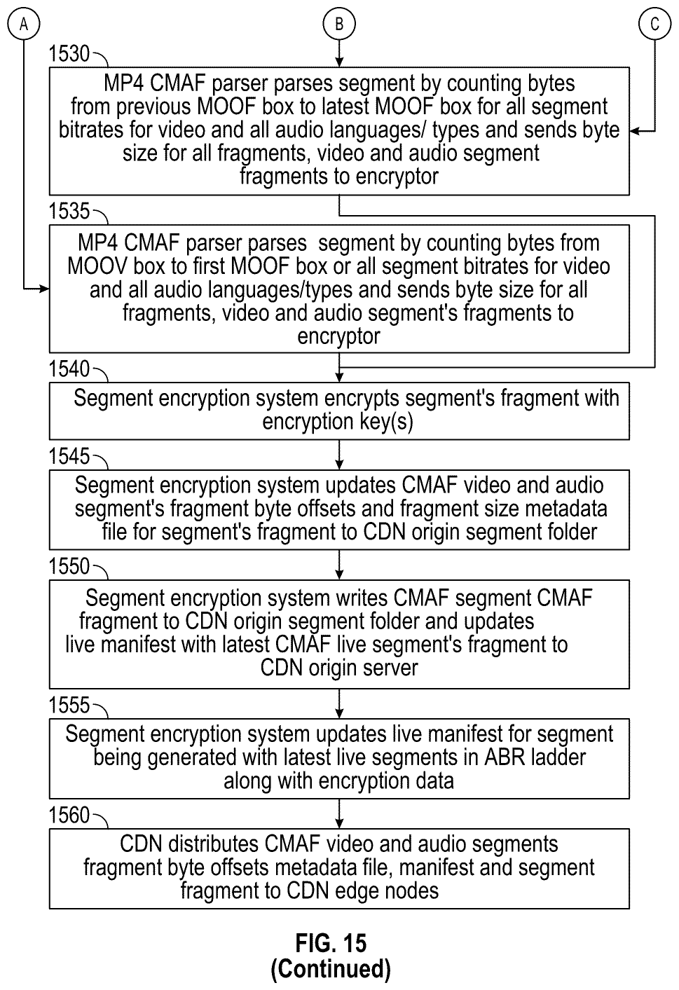

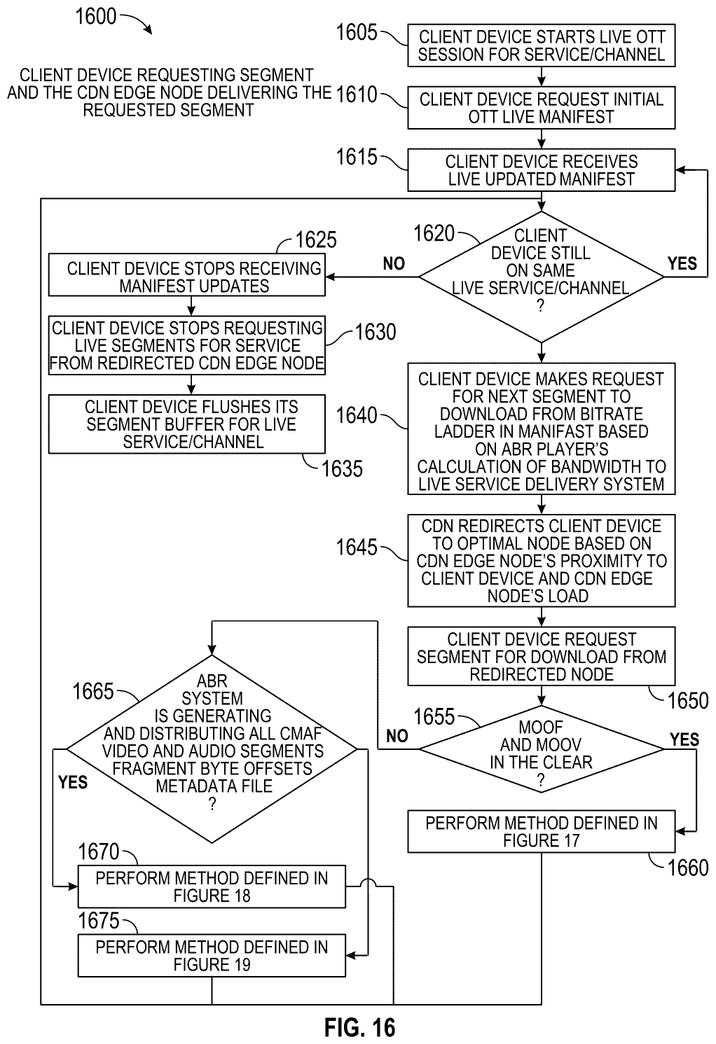

In some embodiments, a process (e.g., 1600 as depicted in FIG. 16) includes a client requesting a CMAF live segment from a bitrate ladder based on the bandwidth calculated by the client device's ABR player. A CDN edge node then delivers a segment, with the delivery either enabling or disabling LAS based on factors such as the bitrate of the fragment of the segment to be delivered, the client's estimated bandwidth, and the size of the fragment from the segment that is to be delivered. The process includes starting a live OTT session for a specific service or channel, requesting the initial OTT live manifest, and receiving the updated live manifest. Depending on whether the client device is still on the same live service/channel, different actions are taken, including stopping receiving manifest updates and requesting live segments for the service from the redirected CDN edge node, or flushing a segment buffer for the live service/channel. The process also includes steps to handle encrypted content (e.g., MOOF and MOOV).

FIG. 16 depicts an example of a process 1600. In the process 1600, for example, a client requests a CMAF live segment from a bitrate ladder. This request is based on the bandwidth calculated by the client device's ABR player. A CDN edge node then delivers a segment. The delivery either enables or disables L4S. This decision is based on at least one of the bitrate of the fragment of the segment to be delivered, the client's estimated bandwidth, the size of the fragment from the segment that is to be delivered, combinations of the same, or the like. Also, for example, the process 1600 may be performed with other embodiments of the disclosure.

For example, the process 1600 includes starting 1605, e.g., at a client device, a live OTT session for a specific service or channel. Also, for example, the process 1600 includes requesting 1610, e.g., at the client device, the initial OTT live manifest. Further, for example, the process 1600 includes receiving, e.g., at the client device, the updated live manifest. Still further, for example, the process 1600 includes determining 1620 if the client device is still on the same live service/channel. Moreover, for example, the process 1600 includes, based at least in part on determining the client device is not on the same live service/channel (1620=“No”), stopping 1625, e.g., at the client device, receiving manifest updates and stopping 1630, e.g., at the client device, requesting live segments for the service from the redirected CDN edge node. In addition, for example, the process 1600 includes flushing 1635, e.g., at the client device, a segment buffer for the live service/channel.

For example, the process 1600 includes, based at least in part on determining the client device is on the same live service/channel (1620=“Yes”), requesting 1640, e.g., at the client device, for the next segment to download from the bitrate ladder in the manifest based on the ABR player's calculation of bandwidth to the live service delivery system. Also, for example, the process 1600 includes redirecting 1645, e.g., at the CDN, the client device to the optimal node based on the CDN edge node's proximity to the client device and the CDN edge node's load. Further, for example, the process 1600 includes requesting 1650, e.g., at the client device, the segment for download from the redirected node.

For example, the process 1600 includes determining 1655 if the MOOF and MOOV are in the clear. Also, for example, the process 1600 includes, based at least in part on determining the MOOF and MOOV are in the clear (1660=“Yes”), performing 1660 the process 71700 defined in FIG. 1717. Further, for example, the process 1600 includes, based at least in part on determining the MOOF and MOOV are not in the clear (1660=“No”), determining 1665 whether the ABR System is generating and distributing an all CMAF video and audio segment's fragment byte offsets metadata file. Still further, for example, the process 1600 includes, based at least in part on determining 1665 the ABR System is generating and distributing all CMAF video and audio segment's fragment byte offsets metadata file (1665=“Yes”), performing 1670 the process 81800 defined in FIG. 1818. Moreover, the process 1600 includes, based at least in part on determining 1665 the ABR System is not generating and distributing all CMAF video and audio segment's fragment byte offsets metadata file (1665=“No”), performing 1675 the process 1900 defined in FIG. 1919. This process 1600 ensures efficient delivery of live OTT content to the client device, considering factors such as the client's bandwidth and the load on the CDN edge nodes. The process 1600 also includes steps to handle encrypted content (e.g., MOOF and MOOV).

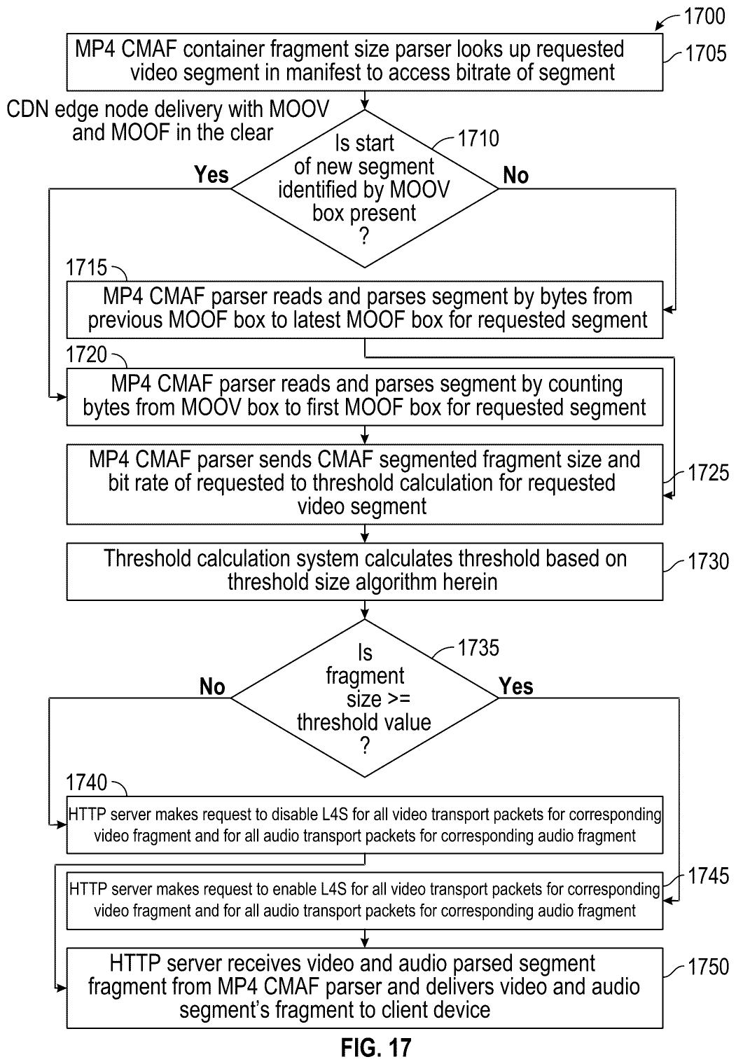

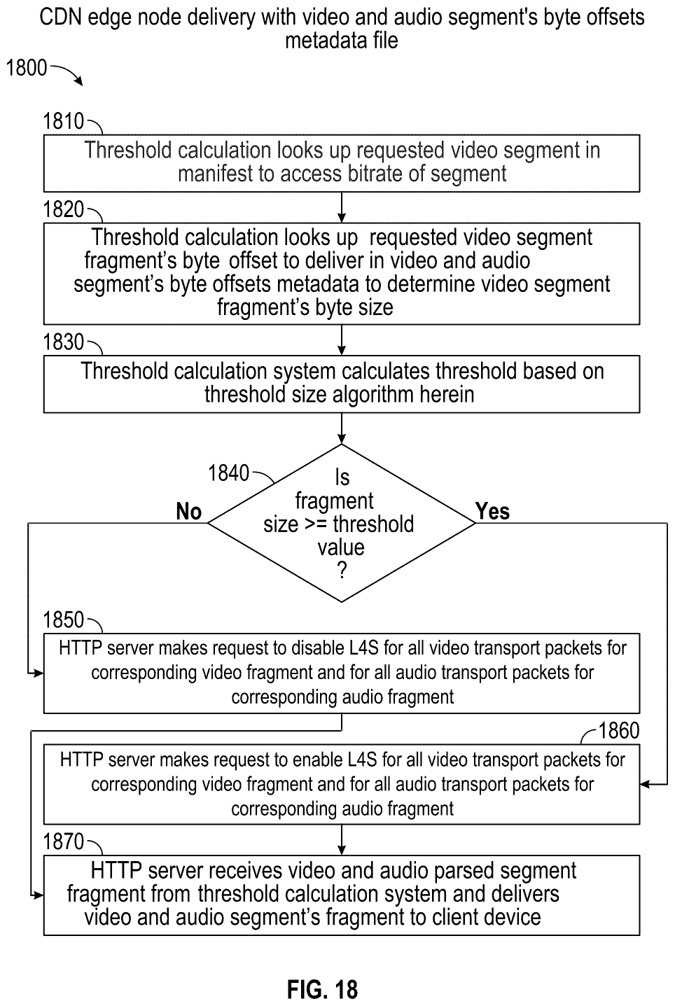

In some embodiments, a process (e.g., 1700 as depicted in FIG. 17) includes enabling or disabling L4S based on MOOV and MOOF atoms in the clear. It includes looking up a requested video segment in a manifest, determining whether a new segment identified by a MOOV box is present, and parsing the segment accordingly. The parsed segment's size and bitrate are sent to a threshold calculator, which calculates a threshold. Depending on whether the fragment size is greater than or equal to the threshold value, L4S is either enabled or disabled for all video packets for a video fragment corresponding audio fragment. In some embodiments, a process (e.g., 1800 as depicted in FIG. 18) includes enabling or disabling L4S based on an OTT ABR system producing a video and audio segment's byte offsets metadata file. It includes looking up a requested video segment in a manifest to access a bitrate of a segment and looking up a requested video segment's fragment's byte offset to determine the video segment's fragment's byte size. Similar to the above process (e.g., 1700), depending on whether the fragment size is greater than or equal to the threshold value, L4S is either enabled or disabled for all video packets for a video fragment corresponding audio fragment.

FIG. 17 depicts an example process 1700 for enabling or disabling L4S based on MOOV and MOOF atoms in the clear, in accordance with some embodiments of the disclosure. For example, the process 1700 includes looking up 1705, e.g., at an MP4 CMAF container fragment size parser, a requested video segment in a manifest to access the bitrate of the segment. Also, for example, the process 1700 includes determining 1710, whether a start of a new segment identified by MOOV box is present. Further, for example, the process 1700 includes, based at least in part on determining the start of the new segment identified by the MOOV box is not present (1710=“No”), reading and parsing 1715, e.g., at the MPF CMAF parser, a segment by counting bytes from a previous MOOF box to a latest MOOF box for the requested segment. Still further, for example, the process 1700 includes, based at least in part on determining the start of the new segment identified by the MOOV box is present (1710=“Yes”), reading and parsing 1720, e.g., at the MPF CMAF parser, a segment by counting bytes from a MOOV box to a first MOOF box for the requested segment.

For example, the process 1700 includes sending 1725, e.g., at the MP4 CMAF parser, a CMAF segmented fragment size and a bit rate of the requested segment to, e.g., a threshold calculator, for the requested video segment. Also, for example, the process 1700 includes calculating 1730, e.g., at the threshold calculation system, a threshold based on a threshold size algorithm (details provided herein). Further, for example, the process 1700 includes determining 1735 whether a fragment size is, e.g., greater than or equal, to a threshold value. Still further, for example, the process 1700 includes, based at least in part on determining the fragment size is not greater than or equal to the threshold value (1735=“No”), requesting 1740, e.g., at an HTTP/3 server, to disable L4S for all video transport fragments for the video fragment and for all audio transport packets for the corresponding audio fragment. Moreover, for example, the process 1700 includes, based at least in part on determining the fragment size is greater than or equal to the threshold value (1735=“Yes”), requesting 1745, e.g., at an HTTP/3 server, to enable L4S for all video transport packets for the video fragment and for all audio transport packets for the corresponding audio fragment. In addition, for example, the process 1700 includes receiving 1750, e.g., at the HTTP/3 server, a video and audio parsed segment's fragment from the MPAF CMAF parser and delivering the video and audio segment's fragment to the client device.

FIG. 18 depicts an example process 1800 for enabling or disabling L4S based on an OTT ABR system producing a video and audio segment's byte offsets metadata file, in accordance with some embodiments of the disclosure. For example, the process 1800 includes looking up 1810, e.g., at a threshold calculator, a requested video segment in a manifest to access the bitrate of the segment. Also, for example, the process 1800 includes looking up 1820, e.g., at the threshold calculator, the requested video segment's fragment's byte offset to deliver in the video and audio segment's byte offsets metadata to determine the video segment's fragment's byte size. Further, for example, the process 1800 includes calculating 1830, e.g., at the threshold calculation system, a threshold based on a threshold size algorithm (details provided herein).

For example, the process 1800 includes determining 1840 whether a fragment size is, e.g., greater than or equal to a threshold value. Still further, for example, the process 1800 includes, based at least in part on determining the fragment size is not greater than or equal to the threshold value (1840=“No”), requesting 1850, e.g., at an HTTP/3 server, to disable L4S for all video transport fragments for the video fragment and for all audio transport packets for the corresponding audio fragment. Moreover, for example, the process 1800 includes, based at least in part on determining the fragment size is greater than or equal to the threshold value (1840=“Yes”), requesting 1860, e.g., at an HTTP/3 server, to enable L4S for all video transport packets for the video fragment and for all audio transport packets for the corresponding audio fragment. In addition, for example, the process 1800 includes receiving 1870, e.g., at the HTTP/3 server, the video and audio parsed segment's fragment from the threshold calculation system and delivering the video and audio segment's fragment to the client device.

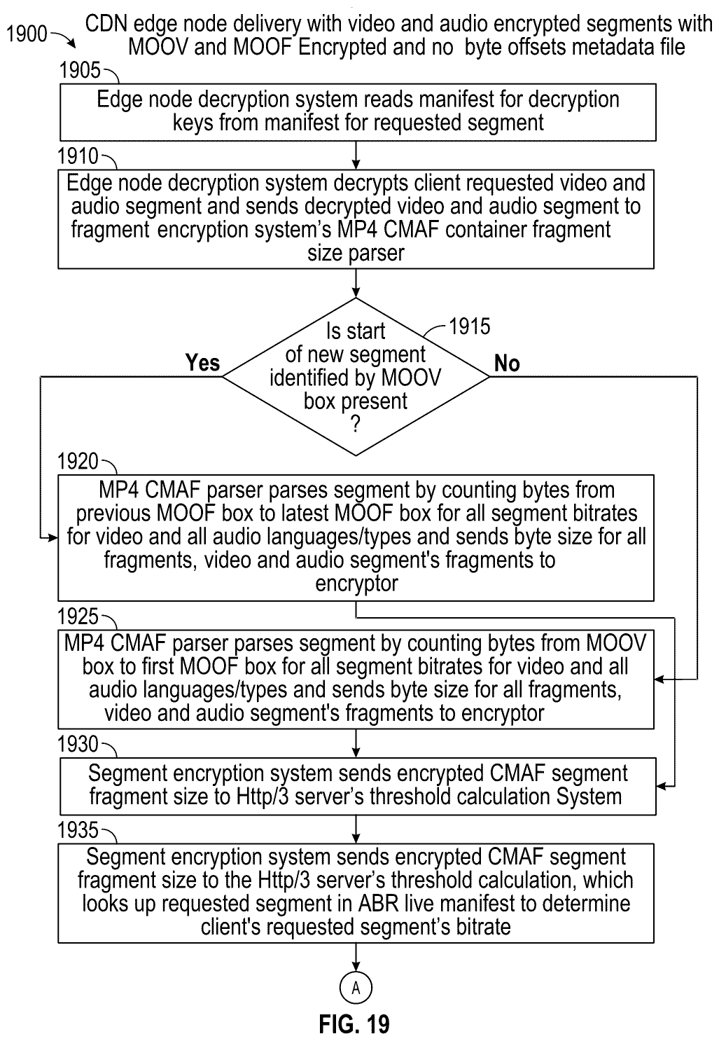

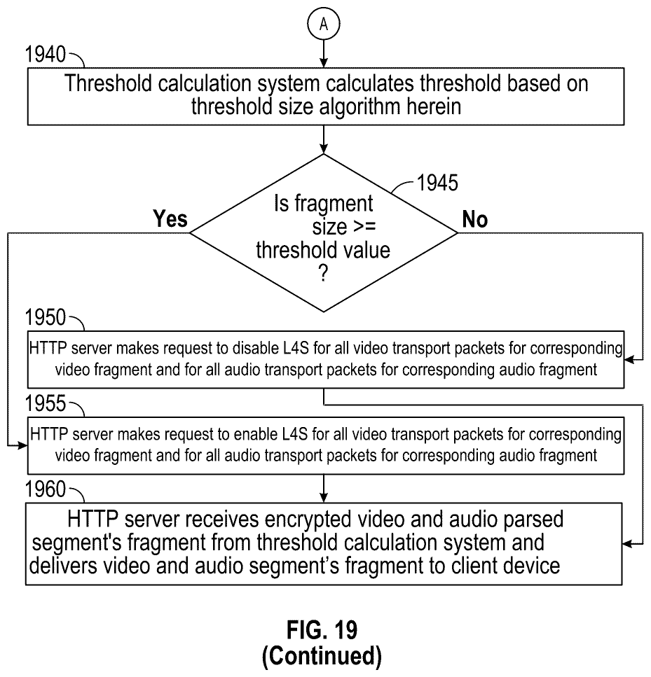

In some embodiments, a process (e.g., 1900 as depicted in FIG. 19) includes enabling or disabling L4S in an OTT ABR system where MOOV and MOOF boxes are not in the clear and there is no byte offsets metadata file for video and audio segments. The process involves CDN edge node delivery with encrypted video and audio segments, reading a manifest for decryption keys, decrypting a client-requested video and audio segment, and sending the decrypted segments to the MP4 CMAF container fragment size parser. The process also includes determining whether a new segment, identified by a MOOV box, is present. If it is, the segment is parsed by counting the bytes from the previous MOOF box to the latest MOOF box for all segment bitrates for the video and all audio languages/types, and the byte size for all fragments is sent to the encryptor. The encrypted CMAF segment's fragment size is then sent to the HTTP/3 server's threshold calculation system, which determines the client's requested segment's bitrate. A threshold is calculated based on a threshold size algorithm. Finally, depending on whether the fragment size is greater than or equal to the threshold value, a request is made to either enable or disable L4S for all video packets for a video fragment corresponding audio fragment. The HTTP/3 server then receives the encrypted video and audio parsed segment's fragment from the threshold calculation system and delivers it to the client device.

FIG. 19 depicts an example process 1900 for enabling or disabling L4S based on an OTT ABR system with MOOV and MOOF boxes not in the clear and where there is no video and audio segment's byte offsets metadata file, in accordance with some embodiments of the disclosure. For example, the process 1900 includes CDN edge node delivery with video and audio encrypted segments with MOOV and MOOF encrypted and no byte offset metadata file. Also, for example, the process 1900 includes reading 1905, e.g., at an edge node decryption system, a manifest for decryption keys from the manifest for a requested segment. Further, for example, the process 1900 includes decrypting 1910, e.g., at an edge node decryption system, a client requested video and audio segment and sending the decrypted video and audio segment's fragment to the encryption system's MP4 CMAF container fragment size parser. Still further, for example, the process 1900 includes determining 1915 whether a start of a new segment identified by a MOOV box is present. Moreover, for example, the process 1900 includes, based at least in part on determining the start of the new segment identified by the MOOV box is present (1915=“Yes”), parsing 1920, e.g., at the MP4 CMAF parser, the segment by counting the bytes from previous MOOF box to the latest MOOF box for all segment bitrates for the video and all audio languages/types and sending the byte size for all fragments, video and audio segment's fragments to the encryptor. In addition, for example, the process 1900 includes, based at least in part on determining the start of the new segment identified by the MOOV box is present (1915=“Yes”), parsing 1925, e.g., at MP4 CMAF parser, the segment by counting the bytes from the previous MOOV box to the first MOOF box for all segment bitrates for the video and all audio languages/types and sending the byte size for all fragments, video and audio segment's fragments to the encryptor.

For example, the process 1900 includes sending 1930, e.g., at a segment encryption system, the encrypted CMAF segment's fragment size to the HTTP/3 server's threshold calculation system. Also, for example, the process 1900 includes sending 1935, e.g., at the segment encryption system, the encrypted CMAF segment's fragment size to the HTTP/3 server's threshold calculation system, which looks up the requested segment in the ABR live manifest to determine the client's requested segment's bitrate. Further, for example, the process 1900 includes calculating 1940, e.g., at the threshold calculation system, a threshold based on the threshold size algorithm (details disclosed herein).

For example, the process 1900 includes determining 1945 whether a fragment size is, e.g., greater than or equal to a threshold value. Also, for example, the process 1900 includes, based at least in part on determining the fragment size is not greater than or equal to the threshold value (1945=“No”), requesting 1950, e.g., at an HTTP/3 server, to disable L4S for all video transport fragments for the video fragment and for all audio transport packets for the corresponding audio fragment. Further, for example, the process 1900 includes, based at least in part on determining the fragment size is greater than or equal to the threshold value (1945=“Yes”), requesting 1955, e.g., at an HTTP/3 server, to enable LAS for all video transport fragments for the video fragment and for all audio transport packets for the corresponding audio packet. Still further, for example, the process 1900 includes receiving 1960, e.g., at the HTTP/3 server, the encrypted video and audio parsed segment's fragment from the threshold calculation system and delivering the video and audio segment's fragment to the client device.

In some embodiments, a threshold size P of a maximum fragment size beyond which L4S may be invoked is given, for example, by the following formula (1):

$$\begin{matrix}\frac{P}{RTT + k \frac{P}{MSS}} - br > δ \\ P > ( br + δ ) ( RTT + k \frac{P}{MSS} )\end{matrix} , \qquad ( 1 )$$

where:
br=segment's requested bitrate,
P=threshold fragment size for invoking L4S,
k=average interpacket latency (packet arrival time) on non-L4S path,
δ=bitrate margin beyond requested bitrate br that could be supported (small positive or small negative number),
RTT=round trip time between CDN edge node and client,
MSS=transport packet maximum segment size,
(br+δδ)=maximum supportable bit rate, and
(RTT+k(P/MSS))=time to transfer a fragment of size P.

In some embodiments, other logic is employed for applying dynamic media-aware L4S enablement at the transport layer, which, e.g., may be derived from information received in the encoding and/or decoding process. For example, a sender, using its transport mechanism, may apply L4S enablement only to packets that represent an I-frame or packets associated with an IDR frame of every segment or every x-segments. The purpose of this is to accelerate the I-frame through the network so that the likelihood of I-frame delay is minimized. The P-frames that are not LAS-enabled and rely on the I-frame for decoding are also more likely to arrive after the I-frame as they have not been accelerated. For example, a sender may apply L4S enablement to packets comprising either I-frames or P-frames, while packets comprising B-frames are not L4S-enabled.

For example, the selective L4S enablement is triggered based on the client's current or predicted future buffer status (e.g., underrun is likely to occur), or);); based on when the initial playback of a media content item is invoked, including “restart”; or based on the transition from a linear to a VOD or cloud digital video recorder (cDVR) version of the media asset. Also, for example, in some approaches, a transition from one delivery mechanism to another is provided (i.e., live to cDVR or VOD, as well as a channel change). In one embodiment, L4S enablement is associated with a predetermined segment(s) or scenes of media content or advertising content when RTB or real-time bidding is being used. This includes delivering a recap of an episode or upon a player entering a state such as preparing to fetch the “Next” episode of a TV show during a binge-watching session.

For example, “fast start” is provided. In one approach, some apps for streaming devices allow buffering of a portion of a content item before the client device receives a user selection of the media item for playback (e.g., buffering while the client device is displaying the movie page). However, Roku does not utilize L4S as disclosed herein. In one embodiment, L4S enablement is associated with a screen component (e.g., guide or EPG portion) of a video application. This enables the quick retrieval and rendering of movie posters, trailers, previews, or the like. Some embodiments, albeit relatively simpler than other embodiments described herein, are implemented at a transport mechanism by reading a same priority queue packet store data structure described herein to determine whether to apply an LAS enablement marking. The encoder, for example, uses a relatively simpler logic to mark which packets are priority, such as selecting only transport packets representing an I-frame or the like.

In some embodiments, L4S increases throughput. For example, in 1997, Matthew Mathis, et al., published a much-referenced model for TCP throughput as bounded by its congestion control algorithms, which considers some link characteristics such as maximum segment size (MSS), round-trip time (RTT) and packet loss probability p, as expressed by formula (2):

$$T = ( MSS * C ) / ( RTT * sqrt ( p ) ) . \qquad ( 2 )$$

Constant C combines several terms that are typically constant for a given combination of TCP implementation, an ACK strategy (e.g., delayed versus non-delayed), and a loss mechanism. As is evident from this model, the throughput is inversely proportional to the RTT. Since RTT reduces for L4S channel pathways, the average throughput increases. Note that depending on the fragment size, a few to several hundreds of transport packets may be L4S-enabled. Low latency CMAF generally uses smaller fragments—this reduces the potential “queue-building” load on the low latency network buffers, albeit the specific large fragment being accelerated may require a deeper buffer relative to the average fragment. Thus, even though the average throughput is increased from a transport standpoint, the increase in throughput from a segment standpoint is instantaneous.

If the network buffers experience congestion at the time that the fragment is being transmitted over the L4S pathway, then the CE bit markings indicate to the sender that they must scale back their throughput. In such a scenario, the sender may reduce throughput by using logic that is similar to a packet loss response, such as re-entering the slow start phase of congestion control (e.g., for TCP Tahoe, reducing CWND to a small multiple of MSS, and halving a slow start threshold optionally including various phases of congestion control).

One of the peculiar artifacts of using L4S and non-L4S pathways with a head-of-line (HOL) blocking protocol such as TCP/QUIC is that if L4S is enabled selectively for one fragment and not for another one, then RTTs for those fragments may be significantly different. An LAS-enabled fragment may arrive sooner, putting fragments out of order at the receiver. This creates a problem in the congestion control algorithms.

In these congestion control algorithms, a number of packets are allowed to be sent, i.e., in flight, without waiting for a previous packet's ACK. However, each packet is acknowledged, as this creates a sliding window at the sender. When a packet arrives out of order, the ACK sent is of the last packet that is received in consecutive order rather than of the packet just received. This is a duplicate ACK. As specified in TCP Reno, the third duplicate ACK triggers “Fast Retransmit”—a negative signal—into the congestion control algorithm. Consequently, the algorithm typically reduces its congestion window, and this has an unnecessarily negative effect on throughput (since out-of-order arrival was not a result of congestion). Thus, if RTT is reduced using L4S enablement for one fragment that is sent after a non-L4S-enabled fragment, the client interprets this as if the fragment sent earlier without L4S enablement was lost, reduces its congestion window, and consequently, reduces throughput.

In some embodiments, independent QUIC streams for L4S and non-L4S transport are provided. As explained herein, QUIC has been steadily replacing TCP as a protocol of choice in HTTP adaptive streaming. QUIC may use independent logical transports (best abstracted as byte-streams) between a source and a destination called streams to reduce HOL blocking that may occur when all the data is sent as a single byte-stream. Streams are individually flow-controlled, allowing an endpoint to limit memory commitment and to apply back pressure. QUIC allows for an arbitrary number of streams to operate concurrently; however, each stream is logically ordered as a sequence of bytes that are received in the order they are sent. Separate streams are, however, not necessarily delivered in the original order. In the IETF, a new working group, MOQ, was formed in 2022 to study possible enhancements that QUIC may bring for low-latency live streaming.

In accordance with the present disclosure, a transmission scheduler is provided, e.g., at a sender, which separates L4S and non-L4S packets into separate QUIC streams. Thus, flow control and congestion control for these streams are performed separately. Even though out-of-order arrival may occur when considering the two streams together, HOL blocking occurs for each stream separately. These features are HTTP/3 ready. It is noted that HTTP/2 also uses multiplexing, using frames and stream IDs to send data over a single TCP connection.

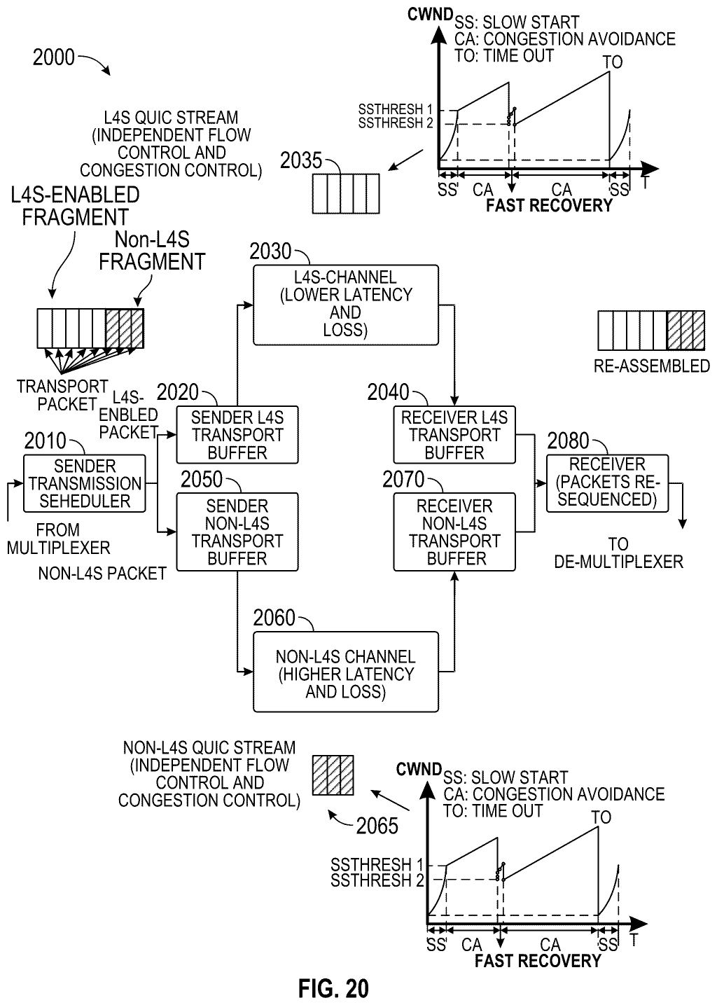

FIG. 20 illustrates how a sender and a receiver maintain separate buffers for transmission and reception of packets via the L4S and non-L4S pathways. The different (out of order) fragments are received and stay in the respective transport buffers until all the prior packets in the original byte-stream (i.e., before splitting the byte-stream into separate L4S and non-L4S streams) have arrived. The packets are then reassembled and supplied to the decoder in sequence.

In some embodiments, a system 2000 includes transmission and reception transport buffers. For example, the system 2000 includes, e.g., at least one of a sender transmission scheduler 2010, a sender L4S transport buffer 2020, an LAS channel (e.g., for lower latency and loss, and, e.g., a channel in which at least one network node has provided an L4S-enabled packet with preferential treatment) 2030, a receiver L4S transport buffer 2040, a sender non-L4S transport buffer 2050, a non-L4S channel (e.g., for higher latency and loss, and, e.g., a channel in which all network nodes treat non-L4S packets using default or non-preferential treatment) 2060, a receiver non-L4S transport buffer 2070, a receiver (e.g., for resequencing packets) 2080, combinations of the same, or the like. Also, for example, the system 2000 receives information from a multiplexer (not shown). For example, the system 2000 receives transport packets, each packet comprising an LAS-enabled fragment or a non-L4S fragment, from the multiplexer. Further, for example, the system 2000 sends information to a demultiplexer (not shown). For example, the system 2000 sends L4S-enabled packets and non-L4S packets to the demultiplexer. Still further, for example, the sender transmission scheduler 2010 sends an L4S-enabled packet to the sender L4S transport buffer 2020, and the sender transmission scheduler 2010 sends a non-L4S-enabled packet to the sender non-L4S transport buffer 2050. Moreover, the L4S-enabled packet proceeds from the scheduler 2010 to the buffer 2020, across the channel 2030 to the buffer 2040, and to the receiver 2080. In addition, for example, the non-L4S packet proceeds from the scheduler 2010 to the buffer 2050, proceeds across the channel 2060 to the buffer 2070, and to the receiver 2080.

For example, L4S-enabled packets are separated by the sender transmission scheduler 2010 into an LAS QUIC stream (e.g., at 2035) that performs independent flow control and congestion control. Also, for example, non-L4S packets are separated by the sender transmission scheduler 2010 into a non-L4S QUIC stream (e.g., at 2065) that performs independent flow control and congestion control. Further, for example, both the L4S QUIC stream and the non-L4S QUIC stream are individually flow-controlled and congestion-controlled, independently from the other stream, by congestion control techniques, such as those used by TCP Tahoe, TCP Reno, and their variants. Still further, for example, TCP Reno has the features slow start, congestion avoidance, and fast retransmit. Moreover, for example, TCP connection goes through slow start, when it starts or restarts transmission of data after a packet loss. Furthermore, one packet is sent in first round trip time (RTT), two packets are sent in second RTT, and the number of packets sent is continuously increased until congestion will not occur. Additionally, for example, when congestion is encountered, a sending rate is decreased and the connection quickly recovers from isolated packet losses through a fast retransmit and recovery algorithm.

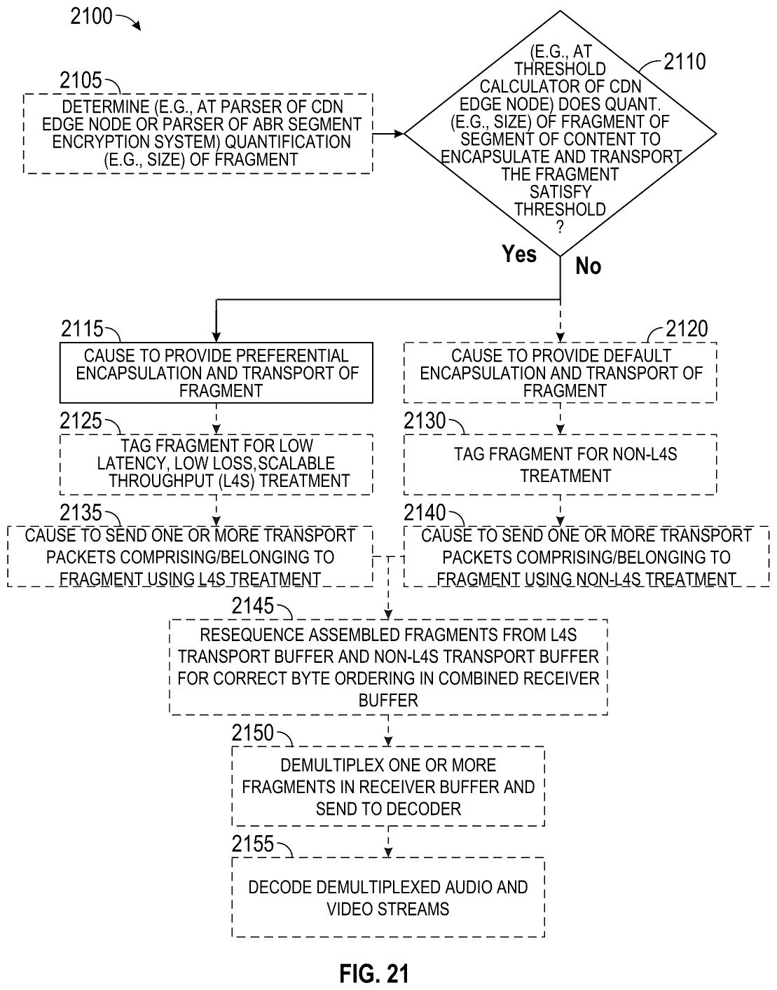

FIG. 21 depicts an example process 2100 for low latency content delivery, in accordance with some embodiments of the disclosure. For example, the process 2100 includes determining 2105, at a parser of a CDN edge node or a parser of an ABR segment encryption system, a quantification of a fragment (e.g., the fragment may be broken down into one or more transport packets for delivery over the network). In some embodiments, the fragment is a fragment of a segment of content to encapsulate and transport the fragment. Additionally, for example, the fragment is broken down into one or more transport packets. For example, the parser of a CDN edge node determines the size of the fragment. Further, for example, the process 2100 includes determining 2110 whether the quantification of the fragment satisfies a threshold (e.g., whether the quantification of the fragment is at or above the threshold). In some embodiments, determining 2110 is done at a threshold calculator of the CDN edge node. In some embodiments, the threshold is based at least in part on a CMAF segment's fragment size and a segment's requested bitrate. Further, for example, the process 2100 includes, based at least in part on determining that the quantification of the fragment satisfies the threshold (2110=“Yes”), causing 2115 to provide preferential encapsulation and transport of the fragment. Further, for example, the preferential encapsulation and transport of the segment comprises tagging 2125 the fragment for L4S treatment. Still further, for example, the process 2100 includes, based at least in part on determining that the quantification of the fragment does not satisfy the threshold (2110=“No”), causing 2120 to provide default encapsulation and transport of the fragment. Moreover, for example, the default encapsulation and transport of the segment comprise tagging 2130 the fragment for non-L4S treatment. In addition, for example, an HTTP/3 server of the CDN edge node performs the tagging 2125 and the tagging 2130. In addition, for example, the parser of the CDN edge node performs the tagging 2125 and the tagging 2130.

For example, the process 2100 includes causing 2135 to send one or more transport packets comprising/belonging to the fragment using the L4S treatment, e.g., at the sender over a stream dedicated to the L4S treatment. Also, for example, the process 1900 includes causing 2140 to send one or more transport packets comprising/belonging to the fragment using the non-L4S treatment, e.g., at the sender over a stream dedicated to default, non-L4S treatment. Further, for example, the process 2100 includes resequencing 2145, e.g., at the receiver, assembled fragments from the L4S transport buffer and the non-LAS transport buffer for correct byte ordering, e.g., in a combined receiver buffer. Still further, for example, the resequencing 2145 may occur prior to demultiplexing 2150 and/or decoding 2155. Moreover, for example, the process 2100 includes demultiplexing 2150 one or more fragments, e.g., at the receiver buffer, and sending the same to a decoder. In addition, the process 2100 includes decoding 2155 demultiplexed audio and video streams.

In addition, for example, the ABR segment encryption system is operatively connected between a content source of the content and a CDN origin. Also, for example, the CDN origin is operatively connected between the ABR segment encryption system and a client device. Further, for example, the ABR segment encryption system comprises an encryptor operatively connected to the parser of the CDN edge node and the encryptor receives the quantification of the fragment (e.g., the fragment size) from the parser. Still further, for example, the encryptor causes CMAF video and audio segment's fragment byte offsets metadata to be sent to at least one of a CDN origin, a CDN, and the CDN edge node. In some embodiments, the CDN edge node comprises the ABR segment encryption system. Moreover, for example, the CDN edge node comprises an encryptor operatively connected to the parser. In addition, for example, the encryptor receives the size of the fragment from the parser and sends an encrypted CMAF segment's fragment size to a threshold calculator of the HTTP/3 server of the CDN edge node.

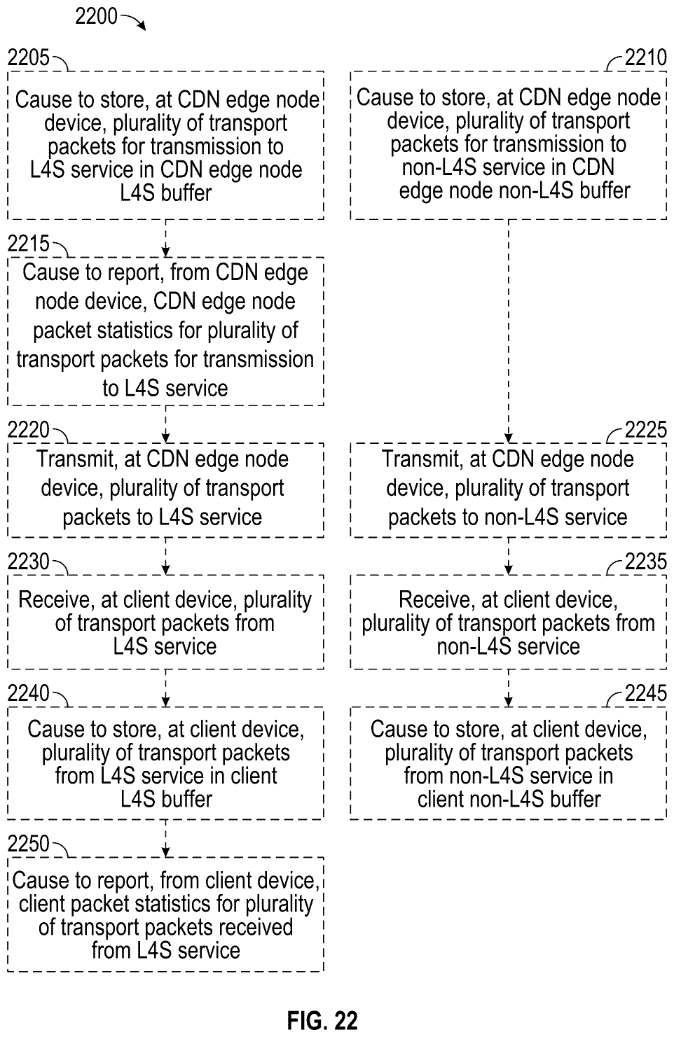

FIG. 22 depicts one or more steps of an example process 2200 for low latency content delivery that is, in some embodiments, combinable with one or more steps of the process of FIG. 21, in accordance with some embodiments of the disclosure. For example, the process 2200 includes causing 2205 to store, e.g., at a CDN edge node device, a plurality of transport packets for transmission to an LAS service in the CDN edge node L4S buffer. Also, for example, the process 2200 includes causing 2210 to store, e.g., at the CDN edge node device, a plurality of transport packets for transmission to a non-L4S service in the CDN edge node non-L4S buffer. Further, for example, the process 2200 includes causing 2215 to report, e.g., from the CDN edge node device, CDN edge node packet statistics for the plurality of transport packets for transmission to the L4S service.

In some embodiments, the process 2200 includes transmitting 2220, e.g., at the CDN edge node device, the plurality of transport packets to the L4S service. Also, for example, the process 2200 includes transmitting 2225, e.g., at the CDN edge node device, the plurality of transport packets to the non-L4S service. Further, for example, the process 2200 includes receiving 2230, e.g., at a client device, the plurality of transport packets from the L4S service. Still further, for example, the process 2200 includes receiving 2235, e.g., at the client device, the plurality of transport packets from the non-L4S service. Moreover, for example, the process 2200 includes causing 2240 to store, e.g., at the client device, the plurality of transport packets received from the L4S service in a client LAS buffer. In addition, for example, the process 2200 includes causing 2245 to store, e.g., at the client device, the plurality of transport packets received from the non-L4S service in the client non-L4S buffer. Furthermore, for example, the process 2200 includes causing 2250 to report, e.g., from the client device, client packet statistics for the plurality of transport packets received from the L4S service.

In some embodiments, for testing and other purposes, packet capture and inspection are provided during use of an application to monitor a live ABR video transmission. For example, in ABR traffic, captured packets are examined at a start of a segment where a large I-frame is delivered to the client device. Also, for example, a determination is made as to whether the packets at the start of the segment (or in a large fragment) are L4S-enabled. Further, for example, since the ECN bits are not encrypted, these can be viewed in a packet browser like Wireshark. Still further, a correlation between L4S-enabled packets and large fragment sizes is determined.

### Incorporations by Reference

Each of the following is hereby incorporated by reference herein in its entirety: (1) Christopher Phillips, Dhananjay Lal, and Reda Harb (the present inventors), U.S. patent application Ser. No. 18/626,659, titled “Application-Flow Aware Broadband Service with Data Caps,” filed Apr. 4, 2024 (Phillips '659); (2) Christopher Phillips, Dhananjay Lal, and Reda Harb, U.S. Provisional Patent Application No. 63/574,668, titled “Intelligent Application Priority Packet Delivery Control,” filed Apr. 4, 2024 (Phillips '668); (3) Christopher Phillips, Dhananjay Lal, and Reda Harb, U.S. patent application Ser. No. 18/667,655, titled “Intelligent Application Priority Packet Delivery Control,” filed May 17, 2024 (Phillips '655); (4) Christopher Phillips and Dhananjay Lal, U.S. patent application Ser. No. 18/744,496, titled “Dynamic Systems and Methods for Media-Aware Low to Ultralow-Latency, Real-Time Transport Protocol Transport Content Delivery,” filed Jun. 14, 2024 (Phillips '496); and (5) Tao Chen and Christopher Phillips, U.S. patent application Ser. No. 18/______,______, titled “Methods to Optimize Video Compression for ABR Streaming” (IDF-11866, 003597-4016-101), filed______ ______, 2024 (Chen 'XXX).

### Predictive Model

In some embodiments, a predictive model and/or predictive engine is modeled, trained, and utilized to predict when a fragment is likely to require preferential treatment (e.g., L4S versus non-L4S and the like). For example, when a system, utilizing the predictive model, determines that a fragment is expected to be relatively large (e.g., above a threshold), the system prepares for higher quality video and switches processing of image units to a preferential service (again, e.g., L4S).

Throughout the present disclosure, in some embodiments, determinations, predictions, likelihoods, and the like are determined with one or more predictive models. In some embodiments, the model receives various forms of data about users, media content items, devices, and more. This includes usage data, load-balancing data, and metadata. The model performs analysis based on hard rules, learning rules, hard models, learning models, usage data, load data, analytics, metadata, profile information, or combinations of these. The model outputs predictions of a future state of any of the devices described. Load-increasing events are determined by load-balancing processes. The model is based on inputs including hard rules, user-defined rules, rules defined by content providers, hard models, learning models, or combinations of these. The model is trained with data using various data processes, analytical processes, and machine learning approaches. It includes regression and classification analyses. An example of a multi-layer neural network is provided. The model is based on data engineering and modeling processes, and is operationalized using registration, deployment, monitoring, and retraining processes. The model is configured to output results to one or multiple devices, which can perform various functions. The devices can be a server, tablet, media display device, network-connected computer, media device, computing device, or combinations of these. The model outputs a current state, future state, determination, prediction, or likelihood. These outputs may be compared to a predetermined or determined standard. If the standard is satisfied or rejected, the predictive process outputs at least one of the current state, future state, determination, prediction, or likelihood to any device or module disclosed.

In some embodiments, the model ingests diverse forms of data about users, digital content items, devices, and more. This encompasses user interaction data, load-distribution data, and metadata. The model conducts analysis based on deterministic rules, learned rules, deterministic models, learned models, user interaction data, load data, analytics, metadata, user profile information, or combinations thereof. The model generates predictions of a future state of any of the described devices. Load-increasing events are identified by load-distribution processes.

The model is constructed based on inputs including deterministic rules, user-defined rules, rules defined by content providers, deterministic models, learned models, or combinations thereof. The model is trained with data using various data processing methods, analytical processes, and machine learning techniques. It includes regression and classification analyses. An example of a deep neural network is provided.

The model is built upon data engineering and modeling processes and is operationalized using registration, deployment, monitoring, and retraining processes. The model is designed to output results to one or multiple devices, which can perform various functions. The devices can be a server, tablet, digital display device, network-connected computer, media device, computing device, or combinations thereof.

The model outputs a current state, future state, determination, prediction, or probability. These outputs may be compared to a predetermined or determined benchmark. If the benchmark is met or not met, the predictive process outputs at least one of the current state, future state, determination, prediction, or probability to any device or module disclosed.

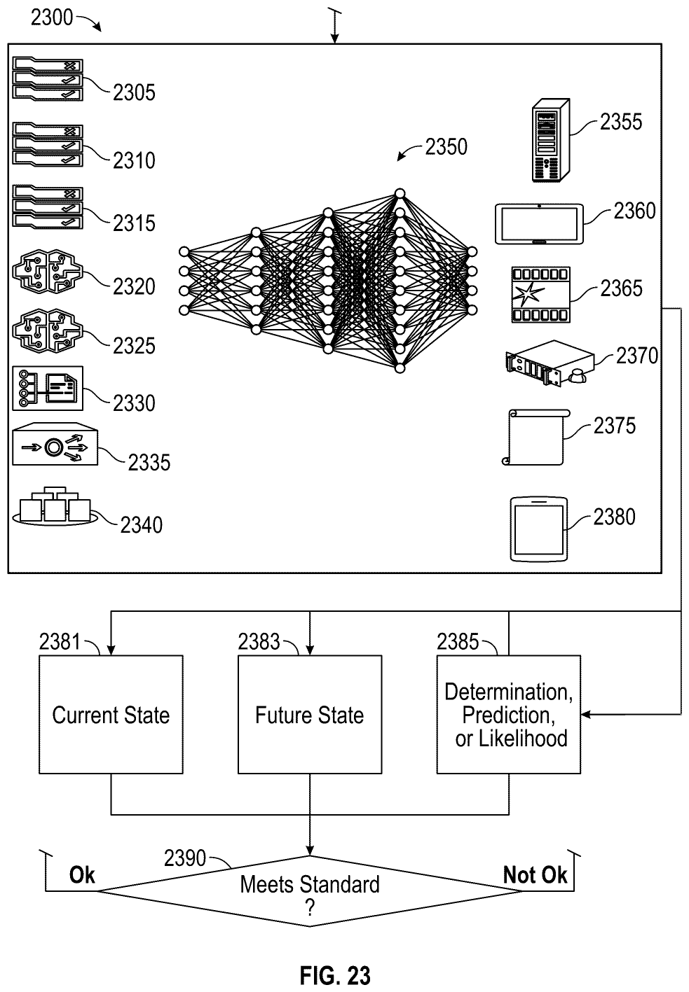

For example, FIG. 23 depicts a predictive model. A prediction process 2300 includes a predictive model 2350 in some embodiments. The predictive model 2350 receives as input various forms of data about one, more or all the users, media content items, devices, and data described in the present disclosure. The predictive model 2350 performs analysis based on at least one of hard rules, learning rules, hard models, learning models, usage data, load data, analytics of the same, metadata, profile information, combinations of the same, or the like. The predictive model 2350 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 2350 is based on input including at least one of a hard rule 2305, a user-defined rule 2310, a rule defined by a content provider 2315, a hard model 2320, a learning model 2325, combinations of the same, or the like.

The predictive model 2350 receives as input usage data 2330. The predictive model 2350 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 2350 receives as input load-balancing data 2335. The predictive model 2350 is based on at least one of load data of the display device, load data of the requesting media device, load data of the media content item, load data of the communication system or network, load data of the profile, load data of the media device, combinations of the same, or the like.

The predictive model 2350 receives as input metadata 2340. The predictive model 2350 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 2350 is trained with data. The training data is developed in some embodiments using one or more data processes including but not limited to data selection, data sourcing, and data synthesis. The predictive model 2350 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 2350 is trained in some embodiments with one or more machine learning approaches including but not limited to supervised learning, unsupervised learning, semi-supervised learning, reinforcement learning, and dimensionality reduction. The predictive model 2350 in some embodiments includes regression analysis including analysis of variance (ANOVA), linear regression, logistic regression, ridge regression, and/or time series. The predictive model 2350 in some embodiments includes classification analysis including decision trees and/or neural networks. In FIG. 23, a depiction of a multi-layer neural network is provided as a non-limiting example of a predictive model 2350, the neural network including an input layer (left side), three hidden layers (middle), and an output layer (right side) with 32 neurons and 192 edges, which is intended to be illustrative, not limiting. The predictive model 2350 is based on data engineering and/or modeling processes. The data engineering processes include exploration, cleaning, normalizing, feature engineering, and scaling. The modeling processes include model selection, training, evaluation, and tuning. The predictive model 2350 is operationalized using registration, deployment, monitoring, and/or retraining processes.

The predictive model 2340 is configured to output results to a device or multiple devices. The device includes means for performing one, more, or all the features referenced herein of the systems, methods, processes, and outputs of one or more of FIGS. 1-22, in any suitable combination. The device is at least one of a server 2355, a tablet 2360, a media display device 2365, a network-connected computer 2370, a media device 2375, a computing device 2380, combinations of the same, or the like.

The predictive model 2350 is configured to output a current state 2381, and/or a future state 2383, and/or a determination, a prediction, or a likelihood 2385, and the like. The current state 2381, and/or the future state 2383, and/or the determination, the prediction, or the likelihood 2385, and the like may be compared 2390 to a predetermined or determined standard. In some embodiments, the standard is satisfied (2390=OK) or rejected (2390=NOT OK). If the standard is satisfied or rejected, the predictive process 2300 outputs at least one of the current state, the future state, the determination, the prediction, the likelihood to any device or module disclosed herein, combinations of the same, or the like. In some embodiments, the predictive model 2350 incorporates one or more LLMs.

### Communication System

A communication system is provided including a computing device, a server, and a communication network. Both the server and the communication network can exist in multiple forms and can connect directly or indirectly. The computing device includes control circuitry, a display, and I/O circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit them to the remote server for processing. Both the server and the computing device can transmit and receive content via the communication network or directly, and the processing circuitry receives the user input and converts it to digital signals.

In some embodiments, the system is a distributed network with an edge device (a type of computing device 2402), a cloud server (a type of server 2404), and an internet of things (IoT) network (a type of communication network 2406). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

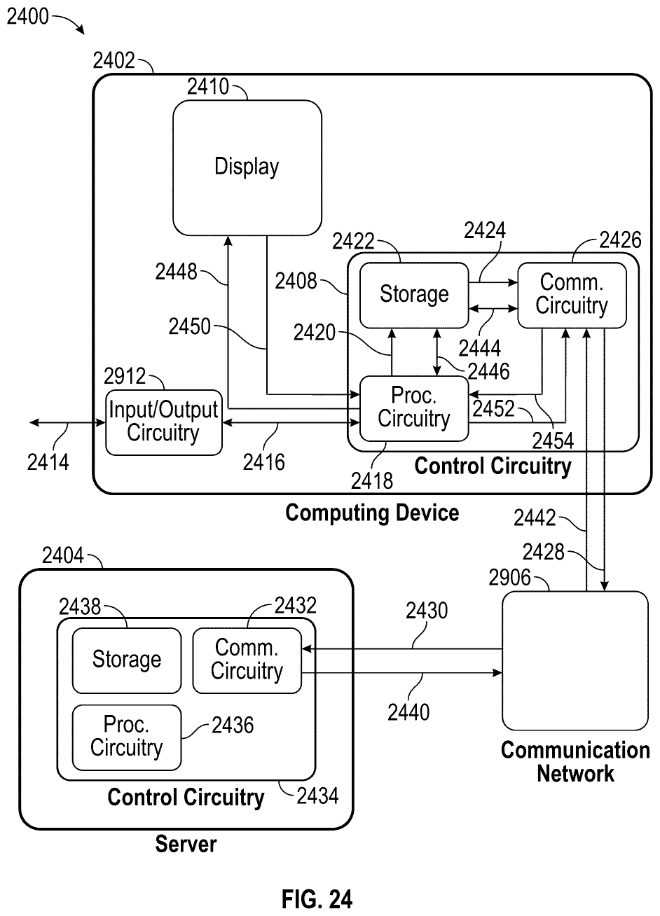

FIG. 24 depicts a block diagram of system 2400, in accordance with some embodiments. The system is shown to include computing device 2402, server 2404, and a communication network 2406. It is understood that while a single instance of a component may be shown and described relative to FIG. 24, additional embodiments of the component may be employed. For example, server 2404 may include, or may be incorporated in, more than one server. Similarly, communication network 2406 may include, or may be incorporated in, more than one communication network. Server 2404 is shown communicatively coupled to computing device 2402 through communication network 2406. While not shown in FIG. 24, server 2404 may be directly communicatively coupled to computing device 2402, for example, in a system absent or bypassing communication network 2406.

Communication network 2406 may include one or more network systems, such as, without limitation, the Internet, LAN, Wi-Fi, wireless, or other network systems suitable for audio processing applications. The system 2400 of FIG. 24 excludes server 2404, and functionality that would otherwise be implemented by server 2404 is instead implemented by other components of the system depicted by FIG. 24, such as one or more components of communication network 2406. In still other embodiments, server 2404 works in conjunction with one or more components of communication network 2406 to implement certain functionality described herein in a distributed or cooperative manner. Similarly, the system depicted by FIG. 24 excludes computing device 2402, and functionality that would otherwise be implemented by computing device 2402 is instead implemented by other components of the system depicted by FIG. 24, such as one or more components of communication network 2406 or server 2404 or a combination of the same. In other embodiments, computing device 2402 works in conjunction with one or more components of communication network 2406 or server 2404 to implement certain functionality described herein in a distributed or cooperative manner.

Computing device 2402 includes control circuitry 2408, display 2410 and input/output (I/O) circuitry 2412. Control circuitry 2408 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 2408 in turn includes communication circuitry 2426, storage 2422 and processing circuitry 2418. Either of control circuitry 2408 and 2434 may be utilized to execute or perform any or all the systems, methods, processes, and outputs of one or more of FIGS. 1-23, or any combination of steps thereof (e.g., as enabled by processing circuitries 2418 and 2436, respectively).

In addition to control circuitry 2408 and 2434, computing device 2402 and server 2404 may each include storage (storage 2422, and storage 2438, respectively). Each of storages 2422 and 2438 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 2422 and 2438 may be used to store several types of content, metadata, and/or other types of data. Non-volatile memory may also be used (e.g., to launch a boot-up routine and other instructions). Cloud-based storage may be used to supplement storages 2422 and 2438 or instead of storages 2422 and 2438. In some embodiments, a user profile and messages corresponding to a chain of communication may be stored in one or more of storages 2422 and 2438. Each of storages 2422 and 2438 may be utilized to store commands, for example, such that when each of processing circuitries 2418 and 2436, respectively, are prompted through control circuitries 2408 and 2434, respectively. Either of processing circuitries 2418 or 2436 may execute any of the systems, methods, processes, and outputs of one or more of FIGS. 1-23, or any combination of steps thereof.

In some embodiments, control circuitry 2408 and/or 2434 executes instructions for an application stored in memory (e.g., storage 2422 and/or storage 2438). Specifically, control circuitry 2408 and/or 2434 may be instructed by the application to perform the functions discussed herein. In some embodiments, any action performed by control circuitry 2408 and/or 2434 may be based on instructions received from the application. For example, the application may be implemented as software or a set of and/or one or more executable instructions that may be stored in storage 2422 and/or 2438 and executed by control circuitry 2408 and/or 2434. The application may be a client/server application where only a client application resides on computing device 2402, and a server application resides on server 2404.

The application may be implemented using any suitable arrangement. For example, it may be a stand-alone application wholly implemented on computing device 2402. In such an approach, instructions for the application are stored locally (e.g., in storage 2422), and data for use by the application is downloaded on a periodic basis (e.g., from an out-of-band feed, from an Internet resource, or using another suitable approach). Control circuitry 2408 may retrieve instructions for the application from storage 2422 and process the instructions to perform the functionality described herein. Based on the processed instructions, control circuitry 2408 may determine a type of action to perform based at least in part on input received from I/O circuitry 2412 or from communication network 2406.

The computing device 2402 is configured to communicate with an I/O device (not shown) via the I/O circuitry 2412. In some embodiments, the user input 2414 is received from the I/O device. A wired and/or wireless connection between the I/O circuitry 2412 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 2408 may include communication circuitry suitable for communicating with an application server (e.g., server 2404) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 2406). In another example of a client/server-based application, control circuitry 2408 runs a web browser that interprets web pages provided by a remote server (e.g., server 2404). For example, the remote server may store the instructions for the application in a storage device.

The remote server may process the stored instructions using circuitry (e.g., control circuitry 2434) and/or generate displays. Computing device 2402 may receive the displays generated by the remote server and may display the content of the displays locally via display 2410. For example, display 2410 may be utilized to present a string of characters. This way, the processing of the instructions is performed remotely (e.g., by server 2404) while the resulting displays, such as the display windows described elsewhere herein, are provided locally on computing device 2404. Computing device 2402 may receive inputs from the user via input/output circuitry 2412 and transmit those inputs to the remote server for processing and generating the corresponding displays.

Alternatively, computing device 2402 may receive inputs from the user via input/output circuitry 2412 and process and display the received inputs locally, by control circuitry 2408 and display 2410, respectively. For example, input/output circuitry 2412 may correspond to a keyboard and/or a set of and/or one or more speakers/microphones which are used to receive user inputs (e.g., input as displayed in a search bar or a display of FIG. 24 on a computing device). Input/output circuitry 2412 may also correspond to a communication link between display 2410 and control circuitry 2408 such that display 2410 updates based at least in part on inputs received via input/output circuitry 2412 (e.g., simultaneously update what is shown in display 2410 based on inputs received by generating corresponding outputs based on instructions stored in memory via a non-transitory, computer-readable medium).

Server 2404 and computing device 2402 may transmit and receive content and data such as media content via communication network 2406. For example, server 2404 may be a media content provider, and computing device 2402 may be a smart television configured to download or stream media content, such as a live news broadcast, from server 2404. Control circuitry 2434, 2408 may send and receive commands, requests, and other suitable data through communication network 2406 using communication circuitry 2432, 2426, respectively. Alternatively, control circuitry 2434, 2408 may communicate directly with each other using communication circuitry 2432, 2426, respectively, avoiding communication network 2406.

It is understood that computing device 2402 is not limited to the embodiments and methods shown and described herein. In nonlimiting examples, computing device 2402 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 2402 receives user input 2414 at input/output circuitry 2412. For example, computing device 2402 may receive a user input such as a user swipe or user touch. It is understood that computing device 2402 is not limited to the embodiments and methods shown and described herein.

User input 2414 may be received from a user selection-capturing interface that is separate from device 2402, such as a remote-control device, trackpad, or any other suitable user movement-sensitive, audio-sensitive or capture devices, or as part of device 2402, such as a touchscreen of display 2410. Transmission of user input 2414 to computing device 2402 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 2412 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 2418 may receive user input 2414 from input/output circuitry 2412 using communication path 2416. Processing circuitry 2418 may convert or translate the received user input 2414 that may be in the form of audio data, visual data, gestures, or movement to digital signals. In some embodiments, input/output circuitry 2412 performs the translation to digital signals. In some embodiments, processing circuitry 2418 (or processing circuitry 2436, as the case may be) conducts disclosed processes and methods.

Processing circuitry 2418 may provide requests to storage 2422 by communication path 2420. Storage 2422 may provide requested information to processing circuitry 2418 by communication path 2446. Storage 2422 may transfer a request for information to communication circuitry 2426 which may translate or encode the request for information to a format receivable by communication network 2406 before transferring the request for information by communication path 2428. Communication network 2406 may forward the translated or encoded request for information to communication circuitry 2432, by communication path 2430.

At communication circuitry 2432, the translated or encoded request for information, received through communication path 2430, is translated or decoded for processing circuitry 2436, which will provide a response to the request for information based on information available through control circuitry 2434 or storage 2438, or a combination thereof. The response to the request for information is then provided back to communication network 2406 by communication path 2440 in an encoded or translated format such that communication network 2406 forwards the encoded or translated response back to communication circuitry 2426 by communication path 2442.

At communication circuitry 2426, the encoded or translated response to the request for information may be provided directly back to processing circuitry 2418 by communication path 2454 or may be provided to storage 2422 through communication path 2444, which then provides the information to processing circuitry 2418 by communication path 2446. Processing circuitry 2418 may also provide a request for information directly to communication circuitry 2426 through communication path 2452, where storage 2422 responds to an information request (provided through communication path 2420 or 2444) by communication path 2424 or 2446 that storage 2422 does not contain information pertaining to the request from processing circuitry 2418.

Processing circuitry 2418 may process the response to the request received through communication paths 2446 or 2454 and may provide instructions to display 2410 for a notification to be provided to the users through communication path 2448. Display 2410 may incorporate a timer for providing the notification or may rely on inputs through input/output circuitry 2412 from the user, which are forwarded through processing circuitry 2418 through communication path 2448, to determine how long or in what format to provide the notification. When display 2410 determines the display has been completed, a notification may be provided to processing circuitry 2418 through communication path 2450.

The communication paths provided in FIG. 24 between computing device 2402, server 2404, communication network 2406, and all subcomponents depicted are examples and may be modified to reduce processing time or enhance processing capabilities for each step in the processes disclosed herein by one skilled in the art.

### Terminology

The terminology used herein is for the purpose of describing particular embodiments only and is not intended to be limiting of the disclosure.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

The invention claimed is:

1. A method for low latency content delivery, the method comprising:
determining, at a content delivery network (CDN) edge node, whether a quantification of a fragment of a segment of the content to encapsulate and transport the fragment satisfies a threshold; and
based at least in part on determining that the quantification of the fragment to encapsulate and transport the fragment satisfies the threshold, causing to provide preferential encapsulation and transport of the fragment to a client device.

2. The method of claim 1, comprising:
based at least in part on determining that the quantification of the fragment to encapsulate and transport the fragment does not satisfy the threshold, causing to provide default encapsulation and transport of the fragment to the client device.

3. The method of claim 1, wherein the quantification comprises a size of the fragment.

4. The method of claim 3, comprising:
determining, at a parser of the CDN edge node, the size of the fragment.

5. The method of claim 3, comprising:
determining, at a parser of an adaptive bitrate (ABR) segment encryption system, the size of the fragment.

6. The method of claim 5, wherein:
the ABR segment encryption system is operatively connected between a content source of the content and a CDN origin, and
the CDN origin is operatively connected between the ABR segment encryption system and the client device.

7. The method of claim 6, wherein:
the ABR segment encryption system comprises an encryptor operatively connected to the parser,
the encryptor receives the size of the fragment from the parser, and
the encryptor causes Common Media Application Format (CMAF) video and audio segment's fragment byte offsets metadata to be sent to at least one of a CDN origin, a CDN, and the CDN edge node.

8. The method of claim 5, wherein the CDN edge node comprises the ABR segment encryption system.

9. The method of claim 8, wherein:
the CDN edge node comprises an encryptor operatively connected to the parser,
the encryptor receives the size of the fragment from the parser, and
the encryptor sends an encrypted Common Media Application Format (CMAF) segment's fragment size to a threshold calculator of an HTTP server of the CDN edge node.

10. The method of claim 1, wherein the preferential encapsulation and transport of the fragment comprises tagging the fragment for a low latency, low loss, and scalable throughput (L4S) service.

11.-20. (canceled)

21. A CDN edge node for low latency content delivery, the CDN edge node comprising:
a parser that determines whether a quantification of a fragment of a segment of the content to encapsulate and transport the fragment satisfies a threshold; and
based at least in part on determining that the quantification of the fragment to encapsulate and transport the fragment satisfies the threshold, causing to provide preferential encapsulation and transport of the fragment to a client device.

22. The CDN edge node of claim 21, comprising:
based at least in part on determining that the quantification of the fragment to encapsulate and transport the fragment does not satisfy the threshold, causing to provide default encapsulation and transport of the fragment to the client device.

23. The CDN edge node of claim 21, wherein the quantification comprises a size of the fragment.

24. The CDN edge node of claim 23, wherein the parser determines, the size of the fragment.

25. The CDN edge node of claim 23, comprising:
an adaptive bitrate (ABR) segment encryption system includes the parser that determines the size of the fragment.

26. The CDN edge node of claim 25, wherein:
the ABR segment encryption system includes an encryptor operatively connected to the parser.

27. The CDN edge node of claim 26, wherein:
the encryptor receives the size of the fragment from the parser, and
the encryptor causes an encrypted Common Media Application Format (CMAF) segment size to be sent to a threshold calculator of the CDN edge node.

28. The CDN edge node of claim 25, wherein the CDN edge node comprises a decryptor.

29. The CDN edge node of claim 28, wherein:
the CDN edge node comprises an encryptor operatively connected to the parser,
the encryptor receives the size of the fragment from the parser, and
the encryptor sends an encrypted Common Media Application Format (CMAF) segment's fragment size to a threshold calculator of an HTTP server of the CDN edge node.

30. The CDN edge node of claim 21, wherein the preferential encapsulation and transport of the fragment comprises tagging the fragment for a low latency, low loss, and scalable throughput (L4S) service.

31.-120. (canceled)
